(19) United States
(12) Patent Application Publication
(10) Pub. No.: US 2025/0277697 A1
(43) Pub. Date: Sep. 4, 2025

(54) LIGHT MEASUREMENT DEVICE, PROJECTING DEVICE, LIGHT MEASUREMENT METHOD, AND NON-TRANSITORY COMPUTER READABLE MEDIUM STORING CONTROL PROGRAM

(71) Applicant: JVCKENWOOD Corporation, Yokohama-shi (JP)

(72) Inventors: Naoya OKAMOTO, Yokohama-shi (JP); Takehiko KURAN, Yokohama-shi (JP)

(21) Appl. No.: 19/213,884

(22) Filed: May 20, 2025

Related U.S. Application Data
(63) Continuation of application No. PCT/JP2023/023638, filed on Jun. 26, 2023.

(30) Foreign Application Priority Data
Dec. 21, 2022 (JP) 2022-204173
Dec. 21, 2022 (JP) 2022-204174
Dec. 21, 2022 (JP) 2022-204175

(51) Int. Cl. G01J 1/44; H04N 9/31

(52) U.S. Cl. CPC G01J 1/44; H04N 9/3155; H04N 9/3161; H04N 9/3194; H04N 9/3167

(57) ABSTRACT

A light measurement device includes a drive circuit configured to separately drive each of a plurality of semiconductor lasers included in a light source; an optical sensor configured to detect light emitted from the light source; and an arithmetic processing circuit configured to calculate at least either of a light amount of each of the plurality of semiconductor lasers and chromaticity of the light emitted from the light source based on a result of the detection by the optical sensor.

### CROSS REFERENCE TO RELATED APPLICATION

This application is based upon and claims the benefit of priority from Japanese patent application No. 2022-204173, filed on Dec. 21, 2022, Japanese Patent Application No. 2022-204174, filed on Dec. 21, 2022, and Japanese Patent Application No. 2022-204175, filed on Dec. 21, 2022, the disclosure of which is incorporated herein in its entirety by reference.

The present disclosure relates to a light amount measurement device, a projecting device, a light amount measurement method, and a control program, and relates to a light amount measurement device, a projecting device, a light amount measurement method, and a control program suitable for accurately measuring a light amount of each of a plurality of semiconductor lasers having different wavelengths which are being lit, which are light sources.

### BACKGROUND

A projecting device which reflects light from a light source by a reflective light modulator to modulate based on image data and selectively reflects the modulated light by a reflective polarization plate to project an image on a projected medium is known. In such projecting device, it is possible to stabilize a light amount of the light source by detecting the light amount of the light source by an optical sensor arranged on an optical path or the like of the light emitted from the light source to feedback-control the light source based on the detected light amount.

Patent Literature 1 discloses a detecting device configured to detect a light amount of light from a light source of a projecting device configured to irradiate the light emitted from a light source to a reflective light modulator configured to modulate irradiated light to reflect based on image data and project the light reflected by the light modulator. This detecting device includes: an optical sensor provided between the light source and the light modulator; a ratio calculator configured to calculate a ratio of return light returning from the light modulator to the light source to the light irradiated to the light modulator based on the image data; and a light amount calculator configured to calculate the light amount of the light emitted from the light source by using a detection output of the optical sensor and the ratio calculated by the ratio calculator. Accordingly, this detecting device detects a light amount of light from a light source with a high degree of accuracy.

[Patent Literature 1] Japanese Patent No. 6569440

### SUMMARY

In the detecting device disclosed in Patent Literature 1, when it is required to measure the light amount of each of the plurality of semiconductor lasers having different wavelengths which are being lit, which are light sources, for example, a plurality of semiconductor lasers having different wavelengths, which are light sources, are sequentially selected, one at a time, and the selected semiconductor lasers are lit, whereby it is possible to measure the light amount of each of the plurality of semiconductor lasers which are being lit.

However, there is a problem, in the above detecting device, that the temperature of each of semiconductor lasers not to be measured which are not being lit becomes lower than the temperature thereof at a time of image projection (in a normal operation) in the period in which the light amount of the semiconductor laser to be measured which is being lit is measured, resulting in a situation where the light amount of each of the plurality of semiconductor lasers which are being lit cannot be accurately measured.

A light measurement device according to one aspect of the present disclosure includes: a drive circuit configured to separately drive each of a plurality of semiconductor lasers included in a light source; an optical sensor configured to detect light emitted from the light source; and an arithmetic processing circuit configured to calculate at least either of a light amount of each of the plurality of semiconductor lasers and chromaticity of the light emitted from the light source based on a result of the detection by the optical sensor.

A light measurement method according to one aspect of the present disclosure includes: separately driving each of a plurality of semiconductor lasers included in a light source; detecting light emitted from the light source by an optical sensor; and calculating at least either of a light amount of each of the plurality of semiconductor lasers and chromaticity of the light emitted from the light source based on a result of the detection by the optical sensor.

A control program according to one aspect of the present disclosure is a control program for causing a computer to execute: processing for separately driving each of a plurality of semiconductor lasers included in a light source; processing for detecting light emitted from the light source by an optical sensor; and processing for calculating at least either of a light amount of each of the plurality of semiconductor lasers and chromaticity of the light emitted from the light source based on a result of the detection by the optical sensor.

### BRIEF DESCRIPTION OF THE DRAWINGS

FIG. 1 illustrates an example of a configuration of an optical system in a projecting device according to a first embodiment;

FIG. 2 is a diagram showing an example of a configuration of the projecting device according to the first embodiment with a focus on a signal processing system;

FIG. 3 is a timing chart showing a method for measuring a light amount of each of laser diodes LD1-LD3 by the projection device according to the first embodiment;

FIG. 4 is a flowchart showing a method for measuring the light amount of each of the laser diodes LD1-LD3 by the projecting device according to the first embodiment;

FIG. 5 is a timing chart showing a method for measuring a light amount of each of laser diodes LD1-LD3 by a projection device according to a second embodiment;

FIG. 6 is a flowchart showing a method for measuring the light amount of each of the laser diodes LD1-LD3 by the projecting device according to the second embodiment;

FIG. 7 is a timing chart showing a chromaticity measurement method by a projecting device according to a third embodiment;

FIG. 8 is a conceptual diagram for describing a chromaticity adjustment method by the projecting device according to the third embodiment;

FIG. 9 is a flowchart showing a method for measuring chromaticity of light before aging degradation by the projecting device according to the third embodiment;

FIG. 10 is a flowchart showing a method for measuring the chromaticity of the light before aging degradation by the projecting device according to the third embodiment;

FIG. 11 is a flowchart showing a method for measuring brightness of the light before aging degradation by the projecting device according to the third embodiment; and

FIG. 12 is a flowchart showing a method for measuring the chromaticity of the light and a method for adjusting the same after aging degradation by the projecting device according to the third embodiment.

### DETAILED DESCRIPTION

### First Embodiment

In the following description, a light measurement device has functions of measuring either of a light amount and chromaticity, and adjusting either of the light amount and the chromaticity. A light measurement device for measuring and adjusting a light amount is also referred to as a light amount measurement device, and a light measurement device for measuring and adjusting chromaticity is also referred to as a chromaticity adjustment device.

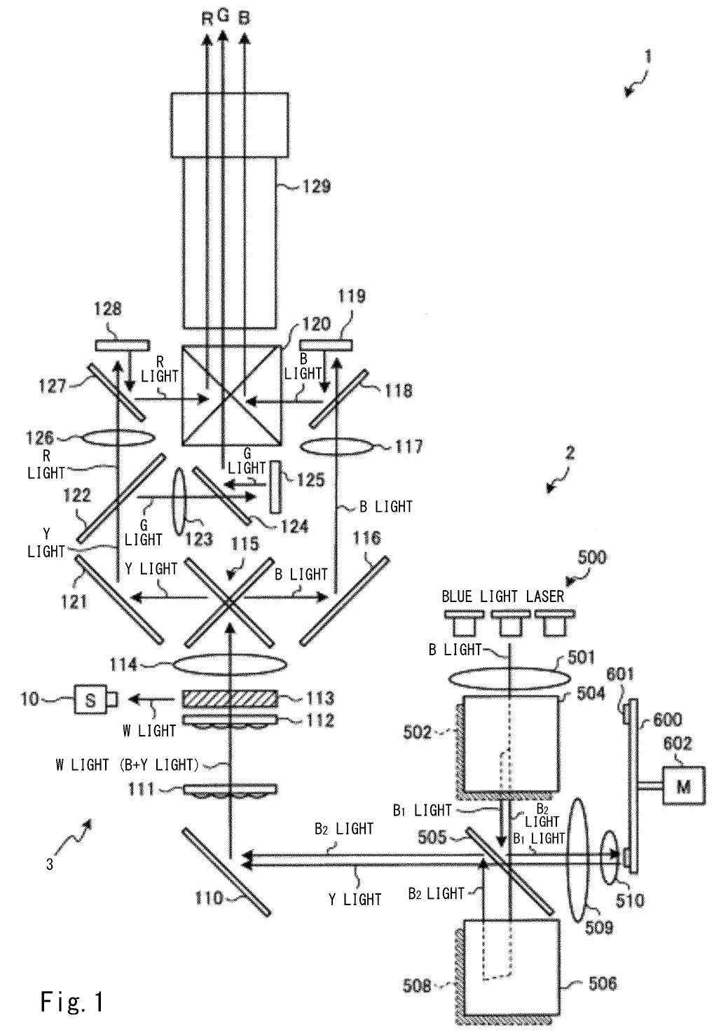

FIG. 1 illustrates an example of a configuration of an optical system in a projecting device 1 according to a first embodiment. Hereinafter, blue light, green light, red light, yellow light, and white light are appropriately represented as B light, G light, R light, Y light, and W light, respectively.

As shown in FIG. 1, the projecting device 1, which is, for example, a projector, includes a light source unit 2 and an illumination optical unit 3 as a configuration of optical system. The light source unit 2, which includes a light source 500 including a plurality of laser diodes (semiconductor lasers) to emit light of a predetermined wavelength band (B light) visible as blue color and a fluorescent substance wheel 600 to which a fluorescent substance excited by the B light emitted from the light source 500 to emit the yellow light (Y light) is applied, emits the B light and Y light. The light emitted from the light source unit 2 is actually the white light (W light) obtained by synthesizing the B light and Y light. A configuration of the light source unit 2 will be described later.

The B light and Y light emitted from the light source unit 2 are incident on the illumination optical unit 3 and reflected by a mirror 110 such that a direction thereof is changed. Meanwhile, the mirror 110 may be omitted depending on a layout of the light source unit 2 and the illumination optical unit 3.

The Y light and B light emitted from the mirror 110 are incident on a lens 114 through fly-eye lenses 111 and 112 and a polarization conversion element 113. The fly-eye lenses 111 and 112 form a uniform illumination optical system which, when each light based on the Y light and B light is irradiated to light modulators 119, 125, and 128 described later, disperses each light so as to be uniformly irradiated to the light modulators 119, 125, and 128.

The polarization conversion element 113 is obtained by combining a polarization beam splitter and a 2/2 plate for converting general light to polarized light and making polarization of the polarized light uniform. In this example, the polarization conversion element 113 converts incident light to S-polarized light. In the example in FIG. 1, an optical sensor 10 which detects the light is provided in proximity to a side surface of the polarization conversion element 113. The optical sensor 10 is a sensor for white light with sensitivity across an entire wavelength region for visible light. The optical sensor 10 in FIG. 1 detects the light leaked from the polarization conversion element 113 out of the B light and Y light incident on the polarization conversion element 113 and outputs a result of the detection depending on a light amount (and chromaticity) of the detected light.

The Y light and B light converted to the S-polarized light are emitted from the polarization conversion element 113 to be incident on a light separator 115 which separates the B light from the Y light through the lens 114. The light separator 115 includes a first dichroic mirror which reflects light of a wavelength band of the B light and transmits light of a wavelength band of the Y light and a second dichroic mirror which reflects the light of the wavelength band of the Y light and transmits the light of the wavelength band of the B light, for example. The B light separated by the light separator 115 is emitted from the light separator 115 to be incident on a mirror 116. The Y light separated by the light separator 115 is emitted from the light separator 115 to be incident on a mirror 121.

The B light incident on the mirror 116 is incident on a reflective polarization plate 118 through a lens 117. The reflective polarization plate 118 transmits one of the S-polarized light and P-polarized light and reflects the other one of them. Herein, suppose that the B light emitted from the lens 117 is the S-polarized light, the light reflected by the reflective light modulator 119 driven based on image data of B color out of the image data of respective colors of R, G, and B described later at a white level (maximum gradation) is the P-polarized light, and the reflective polarization plate 118 has a property of transmitting the S-polarized light and reflecting the P-polarized light.

The B light transmitted through the reflective polarization plate 118 is incident on the reflective light modulator 119. The reflective light modulator 119 is driven according to the image data of the B color and modulates and reflects the incident light on a pixel to pixel basis to emit the resulting light. A reflective liquid crystal element such as a liquid crystal on silicon (LCOS) may be applied, for example, as the reflective light modulator 119. This also applies to the other reflective light modulators 125 and 128 described later.

The B light modulated on a pixel to pixel basis depending on the image data of the B color by the reflective light modulator 119 is reflected by the reflective polarization plate 118 to be emitted in a changed direction and is incident on a first surface of a light synthesizing prism 120.

The Y light separated by the light separator 115 to be incident on the mirror 121 is reflected by the mirror 121 to be emitted from the mirror 121 in a changed direction. The Y light emitted from the mirror 121 is incident on a color component separator 122 and a green light component and a red light component are separated from the Y light. For example, the color component separator 122 is formed of a dichroic mirror which reflects a light of a wavelength band of the green light and transmits a light of a wavelength band of the red light.

The light of the green component (green light, hereinafter G light) separated from the Y light by the color component separator 122 is incident on a reflective polarization plate 124 through a lens 123. Similar to the above-described B light, suppose that the G light is the S-polarized light and the G light is transmitted through the reflective polarization plate 124 to be incident on the reflective light modulator 125 driven according to the image data of the G color. The reflective light modulator 125 modulates and reflects the incident G light on a pixel to pixel basis depending on the image data of the G color to emit the resulting light. The G light emitted from the reflective light modulator 125 is reflected by the reflective polarization plate 124 to be incident on a second surface of the light synthesizing prism 120.

The light of the red component (red light, hereinafter R light) separated from the Y light by the color component separator 122 is incident on a reflective polarization plate 127 through a lens 126. Similar to the above-described B light, suppose that the R light is the S-polarized light and the R light is transmitted through the reflective polarization plate 127 to be incident on the reflective light modulator 128 driven according to the image data of the R color. The reflective light modulator 128 modulates and reflects the incident R light on a pixel to pixel basis depending on the image data of the R color to emit the resulting light. The R light emitted from the reflective light modulator 128 is reflected by the reflective polarization plate 127 to be incident on a third surface of the light synthesizing prism 120.

The light synthesizing prism 120 synthesizes the B light, G light, and R light incident on the first, second, and third surfaces, respectively, to emit the synthesized light from a fourth surface as a light flux. The light flux including the R light, G light, and B light emitted from the light synthesizing prism 120 is emitted outward through an optical projection system (optical projector) 129.

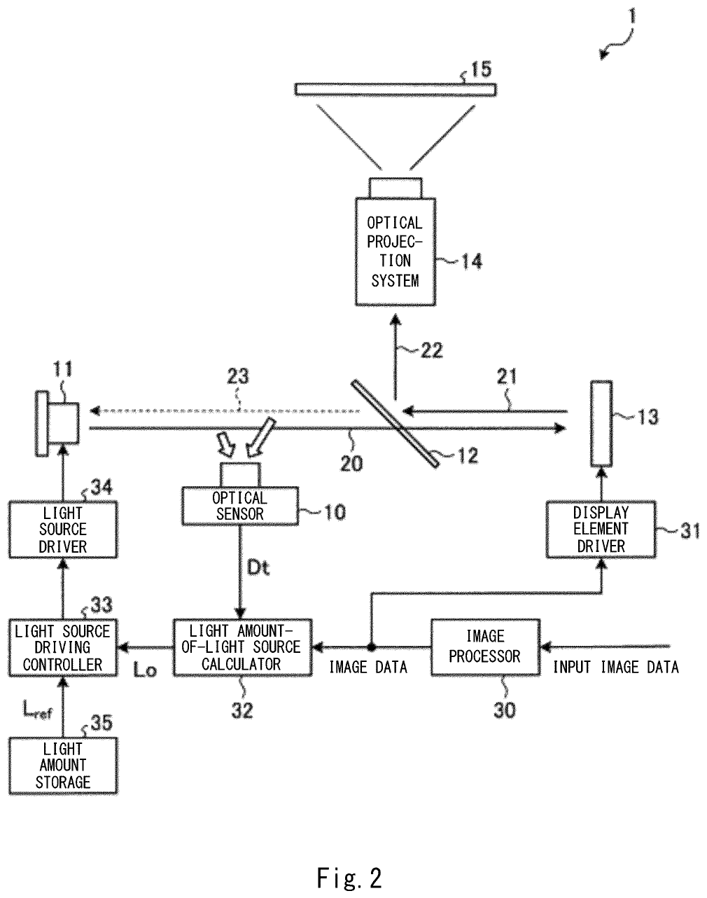

FIG. 2 is a block diagram showing an example of a configuration of a projecting device 1 according to the first embodiment with a focus on a signal processing system. In a configuration of an optical system illustrated in FIG. 2, a light source 11 corresponds to the light source 500 in FIG. 1 and other configuration of a light source unit 2 in FIG. 1 is omitted in FIG. 2. In FIG. 2, a reflective light modulator 13 corresponds to the reflective light modulator 119 to which B light is irradiated in FIG. 1 and a reflective polarization plate 12 corresponds to the reflective polarization plate 118 in FIG. 1. An optical projection system 14 in FIG. 2 corresponds to then optical projection system 129 in FIG. 1.

In FIG. 2, light 20 emitted from the light source 11 including a plurality of laser diodes (semiconductor lasers), for example, is incident on a first surface of the reflective polarization plate 12. Herein, as described with the reflective polarization plate 118 in FIG. 1, the reflective polarization plate 12 transmits S-polarized light and reflects P-polarized light. When the light 20 is the S-polarized light, the light 20 is transmitted through the reflective polarization plate 12 to be irradiated on the reflective light modulator 13. The reflective light modulator 13 is driven by a display element driver 31 described later according to image data and modulates and reflects the incident light 20 according to the image data to emit the resulting light as light 21.

At that time, the light 21 is emitted as the P-polarized light when the image data is of a white level (maximum gradation) by the modulation depending on the image data by the reflective light modulator 13 driven based on the image data of respective colors of R, G, and B. When the image data is of a black level (minimum gradation), the light 21 is emitted as the S-polarized light. Furthermore, when the image data is of gray level gradation between the white level and the black level, the light 21 obtained by mixing a P-polarized component and an S-polarized component depending on the gradation is emitted.

The light 21 is incident on a second surface of the reflective polarization plate 12 and the P-polarized component is incident on the optical projection system 14 as light 22 depending on the modulation of the reflective light modulator 13 to be projected on a projected medium 15 such as a screen. The S-polarized component of the light 21 is transmitted through the reflective polarization plate 12 to return to the light source 11 as light 23. The light 23 transmitted through the reflective polarization plate 12 to return to the light source 11 is hereinafter referred to as “return light”. The return light is generated when the gradation of the image data is other than the white level as described above.

In the above-described example in FIG. 1, the light of the S-polarized component out of the light reflected by the reflective light modulator 119, for example, is transmitted through the reflective polarization plate 118 to be incident on the lens 117 as the return light, thereafter travels inversely along an optical path at the time of incidence to be incident on a mirror 110 through a mirror 116, a light separator 115, a lens 114, a polarization conversion element 113, and fly-eye lenses 112 and 111, and is reflected by the mirror 110 to be emitted to the light source unit 2. In the polarization conversion element 113 on the optical path of the return light, leaking light of the return light is detected by an optical sensor 10 together with leaking light of the light from the light source unit 2.

In FIG. 2, the projecting device 1 includes an image processor 30, the display element driver 31, a light amount-of-a-light source calculator (arithmetic processing circuit) 32, a light source driving controller (adjustment circuit) 33, a light source driver (drive circuit) 34, and a light amount storage (storage circuit) 35 as the configuration of the signal processing system. Hereinafter, a light amount-of-a-light source calculator is also referred to as a light amount calculator. Among them, the image processor 30, the light amount calculator 32, and the light source driving controller 33, for example, may be realized by a program running on a central processing unit (CPU) mounted on the projecting device 1, or a part or all of them may be realized by hardware circuits cooperating with each other.

The image processor 30 is supplied with, for example, input image data input from an external device of the projecting device 1 to the projecting device 1. The input image data includes, for example, data of pixels of the respective colors of R, G, and B, and is input in units of frame at a predetermined frame rate. The image processor 30 applies predetermined image processing such as gamma correction processing using a gamma value y to the supplied input image data to output the resulting image data. The image data output from the image processor 30 is supplied to the display element driver 31 and the light amount calculator 32.

The display element driver 31 generates a driving signal for driving the reflective light modulator 13 based on the image data supplied from the image processor 30. The driving signal is supplied to the reflective light modulator 13. The reflective light modulator 13 is driven on a pixel to pixel basis according to the driving signal supplied from the display element driver 31.

The light amount calculator 32 is supplied with the image data from the image processor 30 and is supplied with a result of the detection in the optical sensor 10 which detects the light. The result of the detection in the optical sensor 10 is the signal corresponding to a light amount (and chromaticity) of the light detected by the optical sensor 10. Herein, the optical sensor 10 detects the light 20 emitted from the light source 11 and the light 23 reflected by the reflective light modulator 13 to be transmitted through the reflective polarization plate 12. The result of the detection in the optical sensor 10 is the signal according to the light amount obtained by adding up the light amount of the light 20 and the light amount of the light 23.

The light amount calculator 32 calculates a value indicating the light amount of the return light based on the image data supplied from the image processor 30 and obtains a light amount Lo of the light 20 from the light source 11 by using the calculated value indicating the return light amount and the result of the detection in the optical sensor 10. Then, the light amount calculator 32 supplies the light amount Lo to the light source driving controller 33.

The light source driving controller 33 generates a driving control signal for controlling the light amount of the light source 11 and supplies the generated driving control signal to the light source driver 34. The light source driver 34 drives the light source 11 according to the driving control signal and causes the light source 11 to emit the light 20 with the light amount according to the driving control signal.

Herein, the light amount storage 35 is connected to the light source driving controller 33. The light amount storage 35, which is, for example, a non-volatile memory embedded in the projecting device 1, stores a reference value Lref indicating the light amount which serves as a reference of the light source 11 in advance. The value is stored in the light amount storage 35 at the time of, for example, factory shipping and system setting of the projecting device 1.

The light source driving controller 33 compares the light amount Lo supplied from the light amount calculator 32 with the reference value Lref of the light amount stored in the light amount storage 35 and generates the driving control signal such that the light amount of the light source 11 is equal to the light amount according to the reference value Lref. In this manner, the light amount of the light source 11 is feedback-controlled based on the result of the detection in the optical sensor 10 and the reference value Lref stored in the light amount storage 35.

Incidentally, while the light amount of each of the plurality of laser diodes included in the light source 11 while they are lit is reduced due to temporal degradation, the amount of the reduction varies depending on an emission wavelength and an individual variation. Therefore, it is required that the projecting device 1 separately measure, by using the optical sensor 10, the light amount of each of the plurality of laser diodes included in the light source 11 while they are lit and separately feedback-control the light amount of each of the plurality of laser diodes while they are lit.

In order to achieve the above object, the projecting device 1 sequentially selects a plurality of laser diodes included in the light source 11, one at a time, and lights the selected laser diode, thereby separately measuring the light amount of each of the plurality of laser diodes while they are lit. Further, in order to prevent the temperature of the laser diodes not to be measured which are not being lit from becoming much lower than the temperature thereof at a time of image projection (in a normal operation) in a period in which a light amount of a laser diode to be measured which is being lit is measured, the projecting device 1 temporarily supplies a current of a current value greater than that at a time of image projection to each of the laser diodes in a period other than the measurement period. Accordingly, the projecting device 1 can accurately measure the light amount of each of the plurality of laser diodes which are being lit under a temperature condition similar to that at a time of image projection (ideally, the same as that at the time of image projection). A specific explanation will be given below.

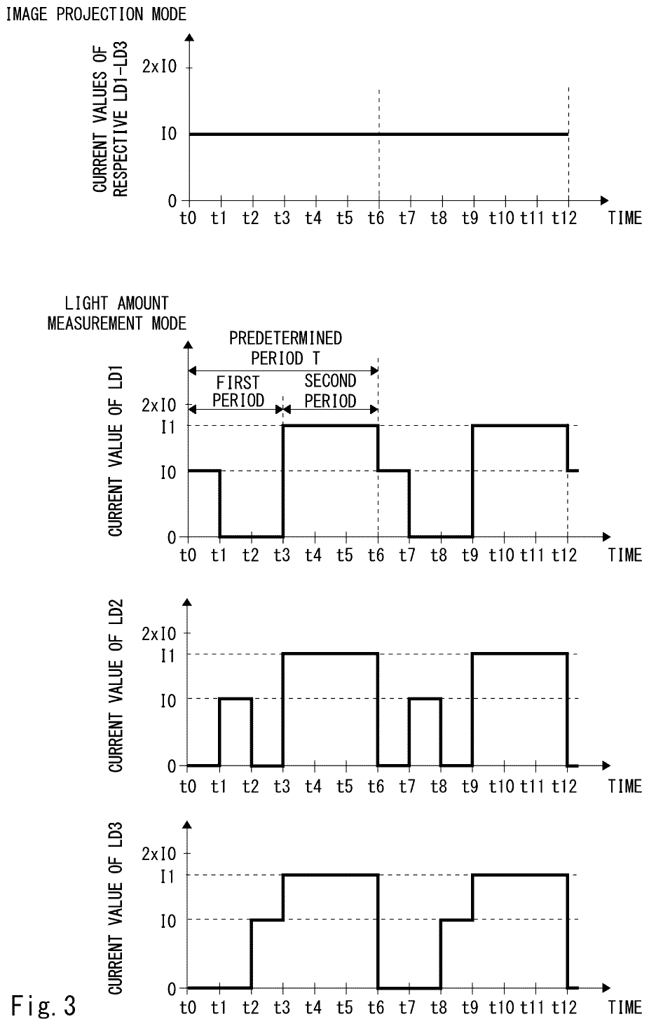

With reference first to FIG. 3, a method for measuring the light amount of each of the laser diodes LD1-LD3 by the projecting device 1 according to the first embodiment will be described. FIG. 3 is a timing chart showing a method for measuring the light amount of each of the laser diodes LD1-LD3 in the projecting device 1 according to the first embodiment. In this embodiment, a case in which the light source 11 includes laser diodes LD1-LD3 that emit blue light having different wavelengths, e.g., 435 nm, 445 nm, and 455 nm, will be described as an example. Here, the light source driver 34, the optical sensor 10, the light amount calculator 32, the light source driving controller 33, the light source driver 34, and the light amount storage 35 constitute a light amount measurement device.

FIG. 3 shows a timing chart of current values of currents supplied to the respective laser diodes LD1-LD3 when an operation mode is a light amount measurement mode. FIG. 3 also shows a timing chart of current values of currents supplied to the respective laser diodes LD1-LD3 when the operation mode is an image projection mode.

The image projection mode indicates an operation mode in which an image is projected on a projected medium by the projecting device 1, and the light amount measurement mode indicates an operation mode in which the light amount of each of the laser diodes LD1-LD3 included in the light source 11 while they are lit is measured.

First, when the operation mode is the image projection mode, the light source driver 34 constantly supplies a current of a current value 10 to each of the laser diodes LD1-LD3, thereby causing each of the laser diodes LD1-LD3 to drive (time t0-t12). Accordingly, each of the laser diodes LD1-LD3 is lit (emits light).

Next, when the operation mode is the light amount measurement mode, the light source driver 34 periodically performs processing in a predetermined period T. Here, the light source driver 34 sequentially supplies, in the predetermined period T, a current of a current value 10 to each of the laser diodes LD1-LD3, one at a time, thereby sequentially causing the laser diodes LD1-LD3 to drive, one at a time. Accordingly, the laser diodes LD1-LD3 are sequentially lit (emit light), one at a time. The optical sensor 10 sequentially detects, one at a time, the laser diodes LD1-LD3 that have been lit. The light amount calculator 32 separately measures, based on the result of the detection in the optical sensor 10, the light amount of each of the laser diodes LD1-LD3 that are being lit. Then the light amount calculator 32 separately calculates, from the plurality of measurement results obtained in the calculation processing in a plurality of predetermined periods T, an average value of the light amounts of each of the laser diodes LD1-LD3 that are being lit.

More specifically, the predetermined period T includes a first period in which the light amount is measured (time t0-t3 and time t6-t9) and a second period in which the light amount is not measured (time t3-t6 and time t9-t12).

In the first period, first, the light source driver 34 supplies the current of the current value 10 to the laser diode LD1 and stops supplying current to the laser diodes LD2 and LD3 (time t0-t1). Only the laser diode LD1 is thus lit. At this time, the optical sensor 10 detects the light amount of only the laser diode LD1 which is being lit. The light amount calculator 32 calculates, based on the result of the detection in the optical sensor 10, the light amount of only the laser diode LD1 which is being lit.

In the first period, next, the light source driver 34 supplies the current of the current value 10 to the laser diode LD2 and stops supplying current to the laser diodes LD1 and LD3 (time t1-t2). Only the laser diode LD2 is thus lit. At this time, the optical sensor 10 detects the light amount of only the laser diode LD2 which is being lit. The light amount calculator 32 calculates, based on the result of the detection in the optical sensor 10, the light amount of only the laser diode LD2 which is being lit.

In the first period, next, the light source driver 34 supplies the current of the current value 10 to the laser diode LD3 and stops supplying current to the laser diodes LD1 and LD2 (time t2-t3). Only the laser diode LD3 is thus lit. At this time, the optical sensor 10 detects the light amount of only the laser diode LD3 which is being lit. The light amount calculator 32 calculates, based on the result of the detection in the optical sensor 10, the light amount of only the laser diode LD3 which is being lit.

Note that the time during which each of the laser diodes LD1-LD3 is lit is set to be equal to or longer than the minimum time that the light amount can be detected by the optical sensor 10.

In the second period, the light source driver 34 supplies a current of a current value Il which is greater than the current value 10 to each of the laser diodes LD1-LD3 (time t3-t6). Accordingly, a temperature decrease due to the laser diodes LD1-LD3 being turned off in the first period is inhibited, whereby the projecting device 1 can accurately measure the light amount of each of the laser diodes LD1-LD3 while they are lit under a temperature condition similar to that at the time of image projection. In the second period, the light amount is not measured.

Note that the current value Il is preferably set in such a way that each one of average current values of the currents supplied to each of the laser diodes LD1-LD3 in the predetermined period T becomes substantially equal to the current value 10. Accordingly, the projecting device 1 can accurately measure the light amount of each of the laser diodes LD1-LD3 while they are lit under substantially the same temperature condition as that at a time of image projection.

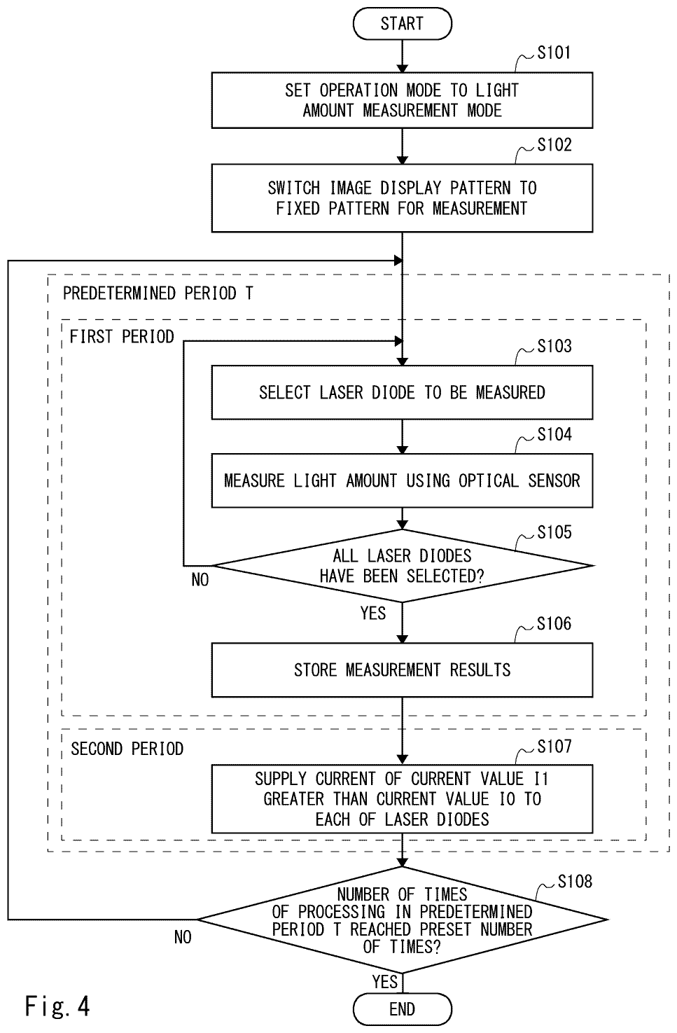

Next, with reference to FIG. 4, a method for measuring the light amount of each of the laser diodes LD1-LD3 in the projecting device 1 according to the first embodiment will be described. FIG. 4 is a flowchart showing the method for measuring the light amount of each of the laser diodes LD1-LD3 in the projecting device 1 according to the first embodiment.

First, the projecting device 1 sets the operation mode to the light amount measurement mode (Step S101). For example, the projecting device 1 switches the operation mode from the image projection mode to the light amount measurement mode. In accordance therewith, the projecting device 1 switches an image display pattern output from the image processor 30 as image data to a fixed pattern for measurement (Step S102). For example, the projecting device 1 switches the image display pattern output from the image processor 30 as image data to a fixed pattern of whole surface white. Accordingly, return light is inhibited.

After that, in the first period in the predetermined period T, the projecting device 1 sequentially supplies, one at a time, the current of the current value IO to each of the laser diodes LD1-LD3, and sequentially measures, one at a time, the light amount of each of the laser diodes LD1-LD3 that have thus lit up (Steps S103-S105). The measurement results are stored in the light amount storage 35 along with additional information such as accumulated light source usage time (Step S106).

After that, in the second period in the predetermined period T, the projecting device 1 supplies the current of the current value Il which is greater than the current value 10 to each of the laser diodes LD1-LD3 (Step S107). Accordingly, a temperature decrease due to the laser diodes LD1-LD3 being turned off is inhibited, whereby the projecting device 1 can continuously measure the light amount of each of the laser diodes LD1-LD3 while they are lit accurately under a temperature condition similar to that at the time of image projection. In the second period, the light amount is not measured.

After that, when the number of times of processing in the predetermined period T has not reached a preset number of times (NO in Step S108), the projecting device 1 returns to the processing in Steps S103-S107. On the other hand, when the number of times of processing in the predetermined period T has reached the preset number of times (YES in Step S108), the projecting device 1 ends the processing of the light amount measurement mode. While the preset number of times is basically two or greater, it may be one provided the temperature is stable. The projecting device 1 calculates an average value of results of measuring the light amount for the preset number of times and then stores this average value in the light amount storage 35 as a final measurement result.

As described above, the projecting device 1 according to this embodiment sequentially selects the laser diodes LD1-LD3 included in the light source 11, one at a time, and lights the selected laser diodes, thereby separately measuring the light amount of each of the laser diodes LD1-LD3 while they are lit. Further, in order to prevent the temperature of laser diodes not to be measured which are not being lit from becoming much lower than the temperature thereof at a time of image projection (in a normal operation) in the period in which the light amount of a laser diode to be measured which is being lit is measured, the projecting device 1 temporarily supplies a current of a current value greater than that at a time of image projection to each of the laser diodes LD1-LD3 in a period other than the measurement period. Accordingly, the projecting device 1 can accurately measure the light amount of each of the laser diodes LD1-LD3 that are being lit under a temperature condition similar to that at a time of image projection (ideally, the same as that at the time of image projection).

Note that the timing when the operation mode is set to the light amount measurement mode may be any timing, and preferably, for example, it may be a timing when the power of the projecting device 1 is turned off after the projecting device 1 operates in the image projection mode. Accordingly, the projecting device 1 can measure the light amount of each of the laser diodes LD1-LD3 in a state in which the temperature is stable as the projecting device 1 operates in the image projection mode. Further, accordingly, the projecting device 1 can easily switch the image display pattern output from the image processor 30 as image data to a fixed pattern of whole surface white in which return light is inhibited.

Further, while the case in which the light source 11 includes three laser diodes LD1-LD3 has been described as an example in this embodiment, this is merely an example. The light source 11 may include any number of two or more laser diodes.

Further, while the case in which the current value of the current supplied to each of the laser diodes LD1-LD3 is constant when the operation mode is the image projection mode has been described as an example in this embodiment, this is merely an example. Even when the operation mode is the image projection mode, currents may be supplied to the respective laser diodes LD1-LD3 by current control the same as that performed when the operation mode is the light amount measurement mode. Accordingly, the projecting device 1 can cause each of the laser diodes LD1-LD3 to drive by common current control regardless of the operation mode. In this case, in order to prevent or reduce flickering (flicker) of an image, the predetermined period T is preferably set to 14 ms or less.

Further, while the case in which the current value of the current supplied to each of the laser diodes LD1-LD3 is constant in the second period in the predetermined period T has been described as an example in this embodiment, this is merely one example, and it may not be constant. Note that, in order to prevent or reduce flickering (flicker) of an image, it is preferably constant.

Further, while the case in which measurement of the light amount of each of the laser diodes LD1-LD3 is continuously performed without intervals has been described as an example in this embodiment, this is merely an example. The measurement of the light amount of each of the laser diodes LD1-LD3 may be sequentially performed at intervals. Accordingly, the projecting device 1 can perform processing performed by the optical sensor 10 and the light amount calculator 32, communication between the optical sensor 10 and the light amount calculator 32, and processing for storing measurement results in the light amount storage 35 in a period in which the light amount is not measured.

Further, while the case in which the projecting device 1 sequentially selects the laser diodes LD1-LD3 included in the light source 11, one at a time, and lights the selected laser diodes, thereby separately measuring the light amount of each of the laser diodes LD1-LD3 while they are lit has been described as an example in this embodiment, this is merely an example. The projecting device 1 may sequentially select the plurality of laser diodes included in the light source 11 for each group of two or more laser diodes having a common wavelength and light the selected laser diodes, thereby separately measuring the light amount of each of groups of the plurality of laser diodes while they are lit. Accordingly, the projecting device 1 can reduce the number of times the light amount is measured compared to the case in which a plurality of laser diodes are sequentially selected, one at a time, whereby it is possible to reduce the measurement period of the light amount and inhibit the reduction of the temperature of the plurality of laser diodes. Consequently, the projecting device 1 can measure the light amount of each of the groups of the plurality of laser diodes more accurately.

When, for example, the light source 11 includes laser diodes LD1-LD4 having an emission wavelength of 435 nm, laser diodes LD5-LD8 having an emission wavelength of 445 nm, and laser diodes LD9-LD12 having an emission wavelength of 455 nm, the projecting device 1 first selects a group of the laser diodes LD1-LD4 having a common wavelength and lights the selected laser diodes, thereby measuring the light amount of the group of the laser diodes LD1-LD4. After that, the projecting device 1 selects a group of the laser diodes LD5-LD8 having a common wavelength and lights the selected laser diodes, thereby measuring the light amount of the group of the laser diodes LD5-LD8. After that, t the projecting device 1 selects a group of the laser diodes LD9-LD12 having a common wavelength and lights the selected laser diodes, thereby measuring the light amount of the group of the laser diodes LD9-LD12.

### Second Embodiment

A method for measuring a light amount of each of laser diodes LD1-LD3 included in a light source 11 in a second embodiment is different from that in the first embodiment. A specific explanation will be given below.

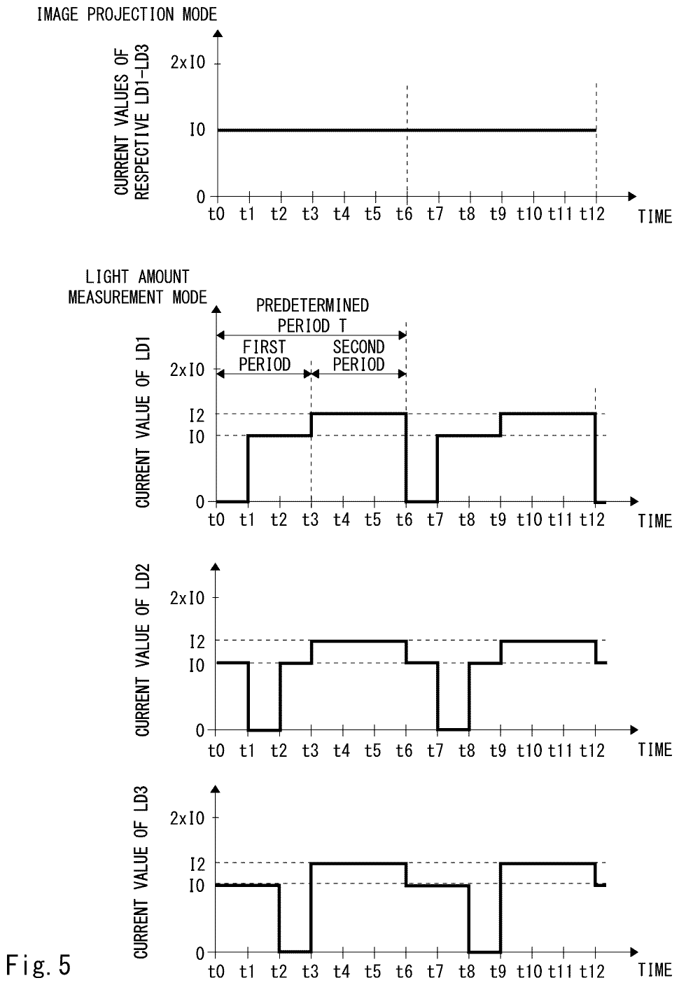

First, with reference to FIG. 5, a method for measuring the light amount of each of the laser diodes LD1-LD3 by a projecting device 1 according to the second embodiment will be described. FIG. 5 is a timing chart showing a method for measuring the light amount of each of the laser diodes LD1-LD3 in the projecting device 1 according to the second embodiment. In this embodiment, a case in which the light source 11 includes laser diodes LD1-LD3 that emit blue light having different wavelengths, e.g., 435 nm, 445 nm, and 455 nm, will be described as an example. A light source driver 34, an optical sensor 10, a light amount-of-a-light source calculator (a light amount calculator) 32, a light source driving controller 33, a light source driver 34, and a light amount storage 35 constitute a light amount measurement device.

FIG. 5 shows a timing chart of current values of currents supplied to the respective laser diodes LD1-LD3 when an operation mode is a light amount measurement mode. FIG. 5 also shows a timing chart of current values of currents supplied to the respective laser diodes LD1-LD3 when the operation mode is an image projection mode.

First, when the operation mode is the image projection mode, the light source driver 34 constantly supplies a current of a current value 10 to each of the laser diodes LD1-LD3, thereby causing each of the laser diodes LD1-LD3 to drive (time t0-t12). Accordingly, each of the laser diodes LD1-LD3 is lit (emits light).

Next, when the operation mode is the light amount measurement mode, the light source driver 34 periodically performs processing in a predetermined period T. The light source driver 34 sequentially selects, in the predetermined period T, one of the laser diodes LD1-LD3, one at a time, stops supplying current to the one laser diode that is selected, and supplies a current of a current value IO to two unselected laser diodes, thereby sequentially causing a pair of two of the laser diodes LD1-LD3 to drive, one pair at a time. Accordingly, the laser diodes LD1-LD3 are sequentially lit (emit light), one pair at a time. The optical sensor 10 sequentially detects, one pair at a time, the light amount of each of the laser diodes LD1-LD3 lit in pairs. The light amount calculator 32 separately calculates, based on the result of the detection in the optical sensor 10, the light amount of each of the laser diodes LD1-LD3 that are being lit. Then the light amount calculator 32 separately calculates, from a plurality of calculation results obtained in the calculation processing in a plurality of predetermined periods T, an average value of the light amounts of each of the laser diodes LD1-LD3 that are being lit.

More specifically, the predetermined period T includes a first period (time t0-t3 and time t6-t9) in which the light amount is measured and a second period (time t3-t6 and time t9-t12) in which the light amount is not measured.

In the first period, first, the light source driver 34 stops supplying current to the laser diode LD1 and supplies the current of the current value IO to each of the laser diodes LD2 and LD3 (time t0-t1). The laser diodes LD2 and LD3 are thus lit. At this time, the optical sensor 10 detects a combined light of the laser diodes LD2 and LD3 which are being lit. The light amount calculator 32 calculates, based on the result of the detection in the optical sensor 10, a total value K23 of the light amounts of the respective laser diodes LD2 and LD3 which are being lit.

In the first period, next, the light source driver 34 stops supplying current to the laser diode LD2 and supplies the current of the current value 10 to each of the laser diodes LD1 and LD3 (time t1-t2). The laser diodes LD1 and LD3 are thus lit. At this time, the optical sensor 10 detects a combined light of the laser diodes LD1 and LD3 which are being lit. The light amount calculator 32 calculates, based on the result of the detection in the optical sensor 10, a total value K13 of the light amounts of the respective laser diodes LD1 and LD3 which are being lit.

In the first period, next, the light source driver 34 stops supplying current to the laser diode LD3 and supplies the current of the current value 10 to each of the laser diodes LD1 and LD2 (time t2-t3). The laser diodes LD1 and LD2 are thus lit. At this time, the optical sensor 10 detects a combined light of the laser diodes LD1 and LD2 which are being lit. The light amount calculator 32 calculates, based on the result of the detection in the optical sensor 10, a total value K12 of the light amounts of the respective laser diodes LD1 and LD2 which are being lit.

The light amount calculator 32 then calculates the light amount of each of the laser diodes LD1, LD2, and LD3 from the aforementioned total values K23, K13, and K12 of the light amounts described above.

Note that the time during which each of the laser diodes LD1-LD3 is lit is set to be equal to or longer than the minimum time that the light amount can be detected by the optical sensor 10.

When the light amount of the laser diode LD1 is denoted by K1, the light amount of the laser diode LD2 is denoted by K2, and the light amount of the laser diode LD3 is denoted by K3, the total value K23 of the light amounts of the respective laser diodes LD2 and LD3, the total value K13 of the light amounts of the respective laser diodes LD1 and LD3, and the total value K12 of the light amounts of the respective laser diodes LD1 and LD2 are expressed as shown in the following Expressions (1), (2), and (3).

$$K 23 = K 2 + K 3 \qquad ( 1 )$$

$$K 13 = K 1 + K 3 \qquad ( 2 )$$

$$K 12 = K 1 + K 2 \qquad ( 3 )$$

Further, from Expressions (1), (2), and (3), the light amounts K1-K3 of the respective laser diodes LD1-LD3 can be expressed as shown by the following Expressions (4), (5), and (6).

$$K 1 = ( K 12 + K 13 - K 23 ) / 2 \qquad ( 4 )$$

$$K 2 = ( K 12 + K 23 - K 13 ) / 2 \qquad ( 5 )$$

$$K 3 = ( K 23 + K 13 - K 12 ) / 2 \qquad ( 6 )$$

Accordingly, the light amount calculator 32 can calculate the light amounts K1-K3 of the respective laser diodes LD1-LD3 from the light amounts K23, K13, and K12 by using Expressions (4), (5), and (6).

In the second period, the light source driver 34 supplies a current of a current value 12 which is greater than the current value 10 to each of the laser diodes LD1-LD3 (time t3-t6). Accordingly, a temperature decrease due to the laser diodes LD1-LD3 being turned off in the first period is inhibited, whereby the projecting device 1 can accurately measure the light amount of each of the laser diodes LD1-LD3 while they are lit under a temperature condition similar to that at a time of image projection. In the second period, the light amount is not measured.

Note that the current value 12 is preferably set in such a way that each one of average current values of the currents supplied to each of the laser diodes LD1-LD3 in the predetermined period T becomes substantially equal to the current value 10. Accordingly, the projecting device 1 can accurately measure the light amount of each of the laser diodes LD1-LD3 while they are lit under substantially the same temperature condition as that at a time of image projection.

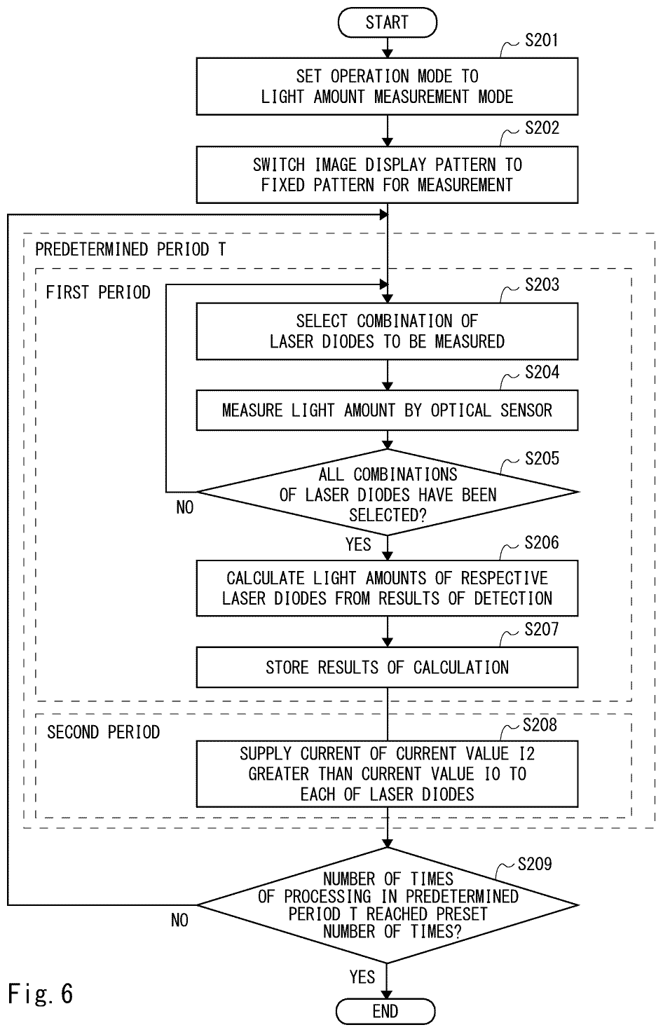

Next, with reference to FIG. 6, a method for measuring the light amount of each of the laser diodes LD1-LD3 in the projecting device 1 according to the second embodiment will be described. FIG. 6 is a flowchart showing the method for measuring the light amount of each of the laser diodes LD1-LD3 in the projecting device 1 according to the second embodiment.

First, the projecting device 1 sets the operation mode to the light amount measurement mode (Step S201). For example, the projecting device 1 switches the operation mode from the image projection mode to the light amount measurement mode. In accordance therewith, the projecting device 1 switches an image display pattern output from the image processor 30 as image data to a fixed pattern for measurement (Step S202). For example, the projecting device 1 switches the image display pattern output from the image processor 30 as image data to a fixed pattern of whole surface white. Accordingly, return light is inhibited.

After that, in the first period in the predetermined period T, the projecting device 1 sequentially supplies the current of the current value IO to the laser diodes LD1-LD3, one pair at a time, including two of the above diodes, and thus sequentially measures, one pair at a time, the light amounts of the laser diodes LD1-LD3 lit in pairs (Steps S203-S205). After that, the projecting device 1 calculates the light amounts of the respective laser diodes LD1-LD3 from light amounts K23, K13, and K12 of the respective pairs by using, for example, Expressions (4), (5), and (6) (Step S206). The results of the calculation are stored in the light amount storage 35 along with additional information such as accumulated light source usage time (Step S207).

After that, in the second period in the predetermined period T, the projecting device 1 supplies the current of the current value 12 which is greater than the current value 10 to each of the laser diodes LD1-LD3 (Step S208). Accordingly, a temperature decrease due to the laser diodes LD1-LD3 being turned off is inhibited, whereby the projecting device 1 can continuously measure the light amount of each of the laser diodes LD1-LD3 while they are lit accurately under a temperature condition similar to that at the time of image projection. In the second period, the light amount is not measured.

After that, when the number of times of processing in the predetermined period T has not reached a preset number of times (NO in Step S209), the projecting device 1 returns to the processing in Steps S203-S208. On the other hand, when the number of times of processing in the predetermined period T has reached the preset number of times (YES in Step S209), the projecting device 1 ends the processing of the light amount measurement mode. While the preset number of times is basically two or greater, it may be one provided the temperature is stable. The projecting device 1 calculates an average value of results of measuring the light amount for the preset number of times, and stores this average value in the light amount storage 35 as a final measurement result.

As described above, the projecting device 1 according to this embodiment sequentially selects the laser diodes LD1-LD3 included in the light source 11, one pair at a time, including two of the above diodes, and lights the selected laser diodes, thereby separately measuring the light amount of each of the laser diodes LD1-LD3 while they are lit. Further, in order to prevent the temperature of laser diodes not to be measured which are not being lit from becoming much lower than the temperature thereof at a time of image projection (in a normal operation) in the period in which the light amount of a laser diode to be measured which is being lit is measured, the projecting device 1 temporarily supplies a current of a current value greater than that at a time of image projection to each of the laser diodes LD1-LD3 in a period other than the measurement period. Accordingly, the projecting device 1 can accurately measure the light amount of each of the laser diodes LD1-LD3 that are being lit under a temperature condition similar to that at a time of image projection (ideally, the same as that at the time of image projection).

Note that the timing when the operation mode is set to the light amount measurement mode may be any timing, and preferably, for example, it may be a timing when the power of the projecting device 1 is turned off after the projecting device 1 operates in the image projection mode. Accordingly, the projecting device 1 can measure the light amount of each of the laser diodes LD1-LD3 in a state in which the temperature is stable as the projecting device 1 operates in the image projection mode. Further, accordingly, the projecting device 1 can easily switch the image display pattern output from the image processor 30 as image data to a fixed pattern of whole surface white in which return light is inhibited.

Further, while the case in which the light source 11 includes three laser diodes LD1-LD3 has been described as an example in this embodiment, this is merely an example. The light source 11 may include any number of two or more laser diodes.

Further, while the case in which the current value of the current supplied to each of the laser diodes LD1-LD3 is constant when the operation mode is the image projection mode has been described as an example in this embodiment, this is merely an example. Even when the operation mode is the image projection mode, currents may be supplied to the respective laser diodes LD1-LD3 by current control the same as that performed when the operation mode is the light amount measurement mode. Accordingly, the projecting device 1 can cause each of the laser diodes LD1-LD3 to drive by common current control regardless of the operation mode. In this case, in order to prevent or reduce flickering (flicker) of an image, the predetermined period T is preferably set to 14 ms or less.

Further, while the case in which the current value of the current supplied to each of the laser diodes LD1-LD3 is constant in the second period in the predetermined period T has been described as an example in this embodiment, this is merely one example, and it may not be constant. Note that, in order to prevent or reduce flickering (flicker) of an image, it is preferably constant.

Further, while the case in which measurement of the light amounts K23, K13, and K12 is continuously performed without intervals has been described as an example in this embodiment, this is merely an example. The measurement of the light amounts K23, K13, and K12 may be sequentially performed at intervals. Accordingly, the projecting device 1 can perform processing performed by the optical sensor 10 and the light amount calculator 32, communication between the optical sensor 10 and the light amount calculator 32, and processing for storing measurement results in the light amount storage 35 in a period in which the light amount is not measured.

Further, while the case in which the projecting device 1 sequentially selects the laser diodes LD1-LD3 included in the light source 11, one at a time, stops supplying current to the one laser diode that is selected, and lights the remaining unselected laser diodes, thereby separately measuring the light amount of each of the laser diodes LD1-LD3 while they are lit has been described as an example in this embodiment, this is merely an example. The projecting device 1 may sequentially select a plurality of laser diodes included in the light source 11 for each group of two or more laser diodes having a common wavelength, stop supplying current to the laser diodes in the group that is selected, and light the remaining unselected laser diodes, thereby separately measuring the light amount of each of groups of the plurality of laser diodes while they are lit. Accordingly, the projecting device 1 can reduce the number of times the light amount is measured compared to that in the case in which a plurality of laser diodes are sequentially selected, one at a time, whereby it is possible to reduce the period in which the light amount is measured and to inhibit the reduction of the temperature of the plurality of laser diodes. Consequently, the projecting device 1 can measure the light amount of each of groups of the plurality of laser diodes more accurately.

When, for example, the light source 11 includes laser diodes LD1-LD4 having an emission wavelength of 435 nm, laser diodes LD5-LD8 having an emission wavelength of 445 nm, and laser diodes LD9-LD12 having an emission wavelength of 455 nm, the projecting device 1 first selects a group of the laser diodes LD1-LD4 having a common wavelength to stop supplying current to the laser diodes LD1-LD4 which are selected, and lights the remaining unselected laser diodes LD5-LD12, thereby measuring a light amount K23′. After that, the projecting device 1 selects a group of the laser diodes LD5-LD8 having a common wavelength to stop supplying current to the laser diodes LD5-LD8 which are selected, and lights the remaining unselected laser diodes LD1-LD4 and LD9-LD12, thereby measuring a light amount K13′. After that, the projecting device 1 selects a group of the laser diodes LD9-LD12 having a common wavelength, stops supplying current to the laser diodes LD9-LD12 which are selected, and lights the remaining unselected laser diodes LD1-LD8, thereby measuring a light amount K12′. Then the projecting device 1 calculates the light amount of each of the laser diodes LD1-LD12 from the measurement values of the light amounts K23′, K13′, and K12′. Since the method for calculating the light amounts at this time is basically the same as the calculation method that uses Expressions (1)-(6) stated above, the descriptions thereof will be omitted.

### Third Embodiment

In the device disclosed in Patent Literature 1, it is considered that, when it is required to return chromaticity of light emitted from a light source that has degraded over time to chromaticity of light before aging degradation, a plurality of semiconductor lasers having different wavelengths, which are light sources, are sequentially selected, one at a time, and the selected semiconductor lasers are lit, whereby, after the chromaticity of the light of each of the plurality of semiconductor lasers is measured, each chromaticity is separately adjusted. However, there is a problem, in this device, that the temperature of each of semiconductor lasers not to be measured which are not being lit becomes lower than the temperature thereof at a time of image projection (in a normal operation) in the period in which the light amount of the semiconductor laser to be measured which is being lit is measured, resulting in a situation where the chromaticity of the light of each of the plurality of semiconductor lasers cannot be accurately measured.

The present disclosure has been made in view of the aforementioned points, and an object of the present disclosure is to provide a chromaticity adjustment device, a projecting device, a chromaticity adjustment method, and a control program suitable for accurately measuring and adjusting chromaticity of light emitted from a light source.

As described above, while the light amount of each of the plurality of laser diodes included in the light source 11 while they are lit is reduced due to temporal degradation, the amount of the reduction varies depending on an emission wavelength and an individual variation. Therefore, there is a problem, in the projecting device according to the related art, that the emission spectrum of the light source 11 changes due to temporal degradation, and the color (chromaticity) of the image is changed from the color before the temporal degradation.

In order to solve the above problem, a projecting device 1 according to the third embodiment compares results of measuring chromaticity of a light emitted from the light source 11 before aging degradation with those after aging degradation and separately controls currents supplied to a plurality of respective laser diodes based on the result of the comparison, thereby adjusting the chromaticity of the light emitted from the light source 11 after aging degradation in such a way that this chromaticity approaches the chromaticity before aging degradation. Here, in order to prevent the temperature of each of the laser diodes not to be measured which are not being lit from becoming lower than the temperature thereof at a time of image projection (in a normal operation) in a period in which chromaticity of the laser diode to be measured which is being lit is measured, the projecting device 1 temporarily supplies a current of a current value greater than that at a time of image projection to a specific laser diode in a period other than the measurement period. Accordingly, the projecting device 1 can accurately measure and adjust the chromaticity of the light emitted from the light source 11 under a temperature condition similar to that at a time of image projection (ideally, the same as that at the time of image projection). A specific explanation will be given below.

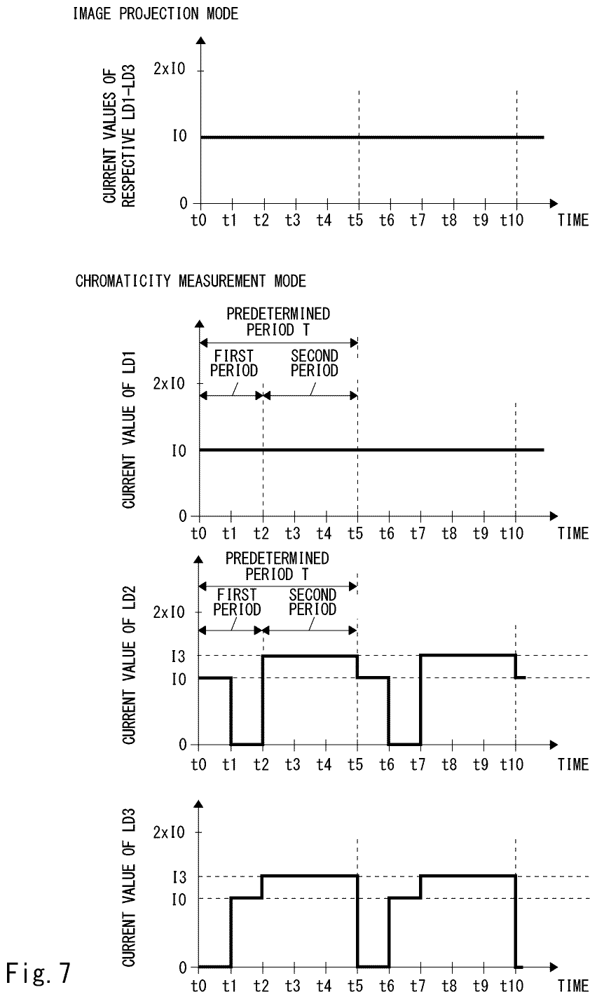

With reference first to FIG. 7, a chromaticity measurement method by the projecting device 1 according to the third embodiment will be described. FIG. 7 is a timing chart showing the chromaticity measurement method by the projecting device 1 according to the third embodiment. In this embodiment, a case in which the light source 11 includes laser diodes LD1-LD3 that emit blue light having different wavelengths, e.g., 435 nm, 445 nm, and 455 nm, will be described as an example. Here, a light source driver 34, an optical sensor 10, a light amount-of-a-light source calculator (a light amount calculator) 32, a light source driving controller 33, a light source driver 34, and a light amount storage 35 constitute a chromaticity adjustment device.

FIG. 7 shows a timing chart of current values of currents supplied to the respective laser diodes LD1-LD3 when an operation mode is a chromaticity measurement mode. FIG. 7 also shows a timing chart of current values of currents supplied to the respective laser diodes LD1-LD3 when the operation mode is an image projection mode.

Here, the image projection mode indicates an operation mode in which an image is projected onto a projected medium by the projecting device 1, and the chromaticity measurement mode is an operation mode in which the chromaticity of the light emitted from the light source 11 is measured. Note that, in the chromaticity measurement mode, measurement of brightness of the light emitted from the light source 11 may be further performed. The operation mode further includes a chromaticity adjustment mode in which the chromaticity of the light emitted from the light source 11 is adjusted. Note that, in the chromaticity adjustment mode, adjustment of the brightness of the light emitted from the light source 11 may be further performed.

Hereinafter, a case in which chromaticity is measured and adjusted after aging degradation as a predetermined period has passed since a time point before aging degradation (reference point), which is, for example, before products are shipped, will be described.

First, when the operation mode is the image projection mode, the light source driver 34 constantly supplies a current of a current value 10 to each of the laser diodes LD1-LD3, thereby causing each of the laser diodes LD1-LD3 to drive (time t0-t10). Accordingly, each of the laser diodes LD1-LD3 is lit (emits light).

Next, when the operation mode is the chromaticity measurement mode, the light source driver 34 periodically performs processing in the predetermined period T. Here, the light source driver 34 first supplies, in the predetermined period T, the current of the current value 10 to each of the laser diodes LD1 and LD2, and then supplies the current of the current value 10 to each of the laser diodes LD1 and LD3. Accordingly, the laser diodes LD1 and LD2 are lit first, and then the laser diodes LD1 and LD3 are lit. The optical sensor 10 first detects a combined light of the laser diodes LD1 and LD2 that have been lit, and then detects a combined light of the laser diodes LD1 and LD3 that have been lit. The light amount calculator 32 calculates, based on the result of the detection in the optical sensor 10, chromaticity during the time when the laser diodes LD1 and LD2 are lit, and then calculates the chromaticity during the time when the laser diodes LD1 and LD3 are lit. Then, the light amount calculator 32 calculates, from a plurality of calculation results in the calculation processing in a plurality of predetermined periods T, an average value of the chromaticity during the time when the laser diodes LD1 and LD2 are lit and an average value of the chromaticity during the time when the laser diodes LD1 and LD3 are lit.

More specifically, the predetermined period T includes a first period in which the chromaticity is measured (time t0-t2 and time t5-t7) and a second period in which the chromaticity is not measured (time t2-t5 and time t7-t10).

In the first period, first, the light source driver 34 supplies the current of the current value 10 to each of the laser diodes LD1 and LD2 and stops supplying current to the laser diode LD3 (time t0-t1). The laser diodes LD1 and LD2 are thus lit. At this time, the optical sensor 10 detects a combined light of the laser diodes LD1 and LD2 which are being lit. The light amount calculator 32 calculates, based on the result of the detection in the optical sensor 10, a chromaticity C12 of the combined light of the laser diodes LD1 and LD2 which are being lit.

In the first period, next, the light source driver 34 supplies the current of the current value 10 to each of the laser diodes LD1 and LD3 and stops supplying current to the laser diode LD2 (time t1-t2). Accordingly, the laser diodes LD1 and LD3 are lit. At this time, the optical sensor 10 detects a combined light of the laser diodes LD1 and LD3 which are being lit. The light amount calculator 32 calculates, based on the result of the detection in the optical sensor 10, a chromaticity C13 of the combined light of the laser diodes LD1 and LD3 which are being lit.

Note that the time during which each of the laser diodes LD1-LD3 is lit is set to be equal to or longer than the minimum time that the light amount can be detected by the optical sensor 10.

In the second period, the light source driver 34 keeps supplying the current of the current value 10 to the laser diode LD1, which serves as a reference, like in the first period (time t2-t5). Further, in the second period, the light source driver 34 supplies a current of a current value 13 which is greater than the current value 10 to each of the laser diodes LD2 and LD3 other than the laser diode LD1 which has been lit for the entire first period (time t2-t5). Accordingly, a temperature decrease due to the laser diodes LD2 and LD3 being turned off in the first period is inhibited, whereby the projecting device 1 can accurately measure the chromaticity of the light emitted from the light source 11 under a temperature condition similar to that at the time of image projection. In the second period, the chromaticity of the light is not measured.

Note that the current value 13 is preferably set in such a way that each one of average current values of the currents supplied to each of the laser diodes LD1-LD3 in the predetermined period T becomes substantially equal to the current value 10. Accordingly, the projecting device 1 can accurately measure the chromaticity of the light emitted from the light source 11 under substantially the same temperature condition as that at a time of image projection.

While the case in which the reference laser diode is the laser diode LD1 has been described as an example in this embodiment, this is merely an example. The reference laser diode may be any one of the laser diodes LD1-LD3. The reference laser diode is preferably the one of the laser diodes LD1-LD3 having the shortest wavelength or the longest wavelength. Accordingly, the difference between the chromaticity of the light of the reference laser diode and the chromaticity of the light of the laser diode which forms a pair with the reference laser diode at the time of measurement of chromaticity becomes great, whereby it becomes easy to detect a change in the chromaticity before and after aging degradation.

When the chromaticity of the light of each of the laser diodes LD1-LD3 is known, the reference laser diode is preferably one of the laser diodes with the shortest wavelength or the laser diode with the longest wavelength whose difference in the chromaticity from those of other laser diodes becomes the largest. When spectral sensitivity characteristics of the optical sensor 10 are known, the reference laser diode is preferably one of the laser diodes with the shortest wavelength or the laser diode with the longest wavelength whose sensitivity by the optical sensor 10 is high. Further, when the peak sensitivity wavelength of the optical sensor 10 is known, the reference laser diode is preferably one of the laser diodes with the shortest wavelength or the longest wavelength which is closer to the peak sensitivity wavelength of the optical sensor 10. Therefore, it becomes much easier to detect a change in the chromaticity before and after aging degradation.

When brightness is measured, the light source driver 34 supplies the current of the current value 10 to each of the laser diodes LD1-LD3. The laser diodes LD1-LD3 are thus lit. At this time, the optical sensor 10 detects a combined light of the laser diodes LD1-LD3 which are being lit. The light amount calculator 32 calculates, based on the result of the detection in the optical sensor 10, brightness of the combined light of the laser diodes LD1-LD3 which are being lit.

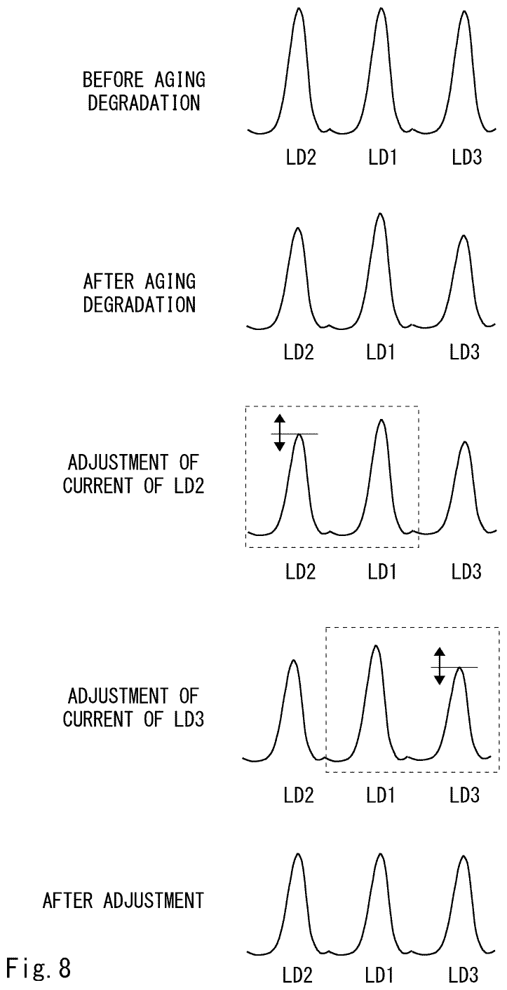

With reference next to FIG. 8, a chromaticity adjustment method by the projecting device 1 according to the third embodiment will be described. FIG. 8 is a conceptual diagram for describing the chromaticity adjustment method by the projecting device 1 according to the third embodiment.

The light amount storage 35 stores information on chromaticity C12_ini of the combined light of the laser diodes LD1 and LD2 at a time point before aging degradation (reference point), which is, for example, before products are shipped, chromaticity C13_ini of the combined light of the laser diodes LD1 and LD3 at the reference point, and brightness BA_ini of the combined light of the laser diodes LD1-LD3 at the reference point. The chromaticity C12_ini, the chromaticity C13_ini, and the brightness BA_ini are measured, at the reference point before aging degradation, by a method similar to the method of measuring the chromaticities C12 and C13 and the brightness BA after aging degradation.

Note that the ratio of the light amounts of the respective laser diodes LD1-LD3 before aging degradation is different from that of the light after aging degradation. The projecting device 1 makes the ratio of the light amounts of the respective laser diodes LD1-LD3 after aging degradation approach the ratio thereof before aging degradation, thereby causing the chromaticity of the light emitted from the light source 11 to approach that of the light before aging degradation.

Specifically, first, the light source driving controller 33 of the projecting device 1 adjusts the current value of the current supplied to the laser diode LD2 in a state in which the current value of the current supplied to the reference laser diode LD1 is fixed, thereby making the chromaticity C12 of the combined light of the laser diodes LD1 and LD2 approach the chromaticity C12_ini at the reference point. Ideally, the light source driving controller 33 makes the chromaticity C12 of the combined light of the laser diodes LD1 and LD2 substantially equal to the chromaticity C12_ini at the reference point. After that, the light source driving controller 33 adjusts the current value of the current supplied to the laser diode LD3 in a state in which the current value of the current supplied to the reference laser diode LD1 is fixed, thereby making the chromaticity C13 of the combined light of the laser diodes LD1 and LD3 approach the chromaticity C13_ini at the reference point. Ideally, the light source driving controller 33 makes the chromaticity C13 of the combined light of the laser diodes LD1 and LD3 substantially equal to the chromaticity C13_ini at the reference point.

Accordingly, the ratio of the light amounts of the respective laser diodes LD1-LD3 approaches that before aging degradation, whereby the chromaticity of the light emitted from the light source 11 approaches that of the light before aging degradation. Ideally, the ratio of the light amounts of the respective laser diodes LD1-LD3 becomes equal to that before aging degradation, whereby the chromaticity of the light emitted from the light source 11 becomes equal to that of the light before aging degradation.

When the brightness is adjusted, the light source driving controller 33 adjusts the light amounts of the respective laser diodes LD1-LD3 in a state in which the ratio of the light amounts of the respective laser diodes LD1-LD3 is maintained, thereby causing the brightness BA of the light emitted from the light source 11 to approach the brightness BA_ini at the reference point (ideally, they are made the same).

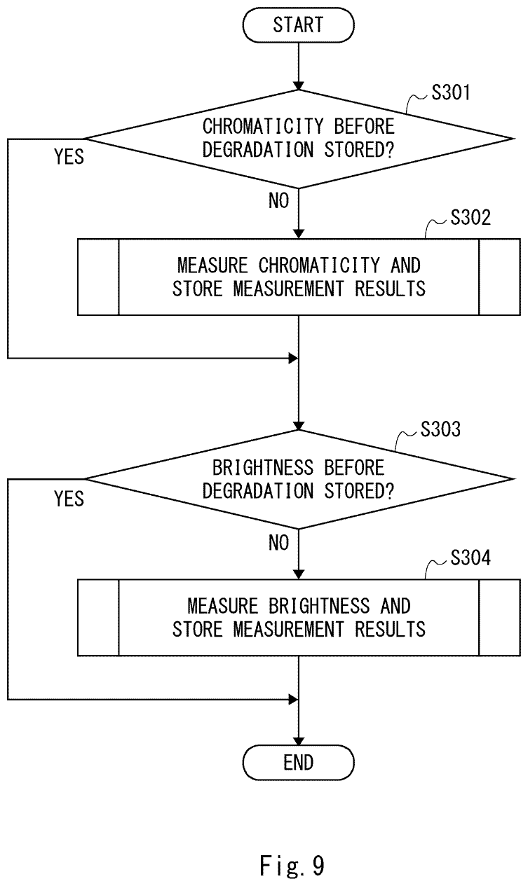

Next, with reference to FIG. 9-11, a method for measuring the chromaticity of the light before aging degradation by the projecting device 1 according to the third embodiment will be described. FIGS. 9-11 are flowcharts showing a method for measuring the chromaticity of the light before aging degradation by the projecting device 1 according to the third embodiment. FIGS. 9-11 also show, in addition to the method for measuring the chromaticity of the light before aging degradation, a method for measuring the brightness of the light before aging degradation.

First, the projecting device 1 determines whether the chromaticity of the light of the light source 11 at the reference point before aging degradation is stored in the light amount storage 35 (Step S301). When the chromaticity of the light of the light source 11 at the reference point is stored in the light amount storage 35 (YES in Step S301), the process proceeds to the processing in Step S303. On the other hand, when the chromaticity of the light of the light source 11 at the reference point is not stored in the light amount storage 35 (NO in Step S301), the projecting device 1 measures the chromaticity of the light of the light source 11 at the reference point and stores the measurement results (Step S302).

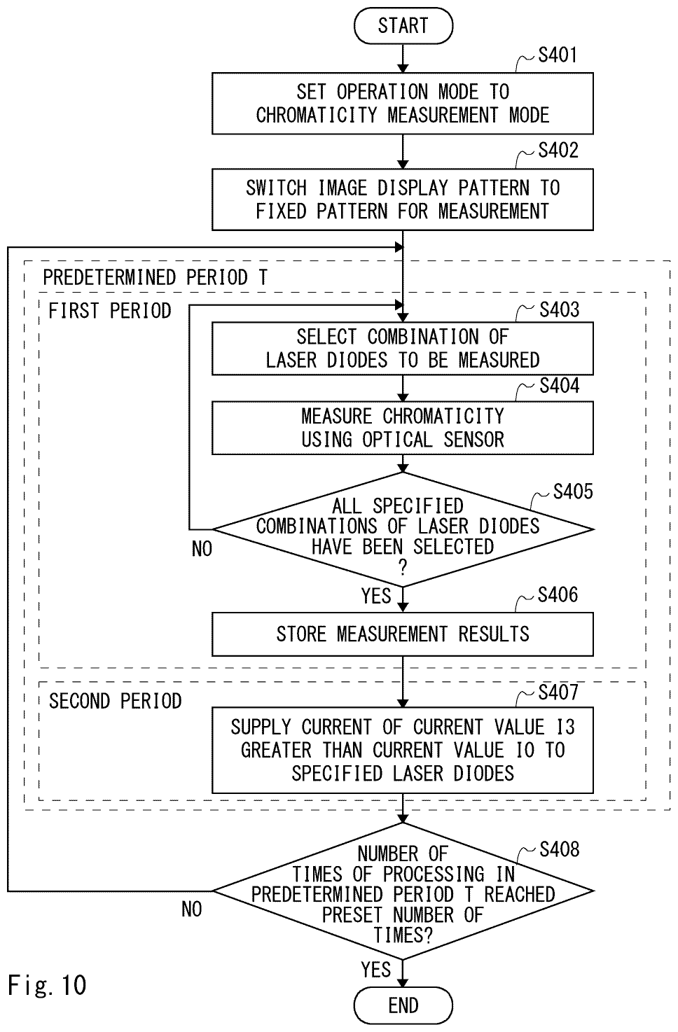

FIG. 10 shows detailed processing in Step S302, that is, detailed processing regarding measurement of chromaticity and storage of measurement results. As shown in FIG. 10, first, the projecting device 1 sets the operation mode to the chromaticity measurement mode (Step S401). In accordance therewith, the projecting device 1 switches an image display pattern output from the image processor 30 as image data to a fixed pattern for measurement (Step S402). For example, the projecting device 1 switches the image display pattern output from the image processor 30 as image data to a fixed pattern of whole surface white. Accordingly, return light is inhibited.

After that, the projecting device 1 supplies, in the first period in the predetermined period T, the current of the current value 10 to each of the laser diodes LD1 and LD2, and then supplies the current of the current value 10 to each of the laser diodes LD1 and LD3. At the same time, the projecting device 1 measures the chromaticity C12_ini of the combined light of the laser diodes LD1 and LD2 that have been lit, and then measures the chromaticity C13_ini of the combined light of the laser diodes LD1 and LD3 that have been lit (Step S403-S405). These measurement results are stored in the light amount storage 35 (Step S406).

After that, the projecting device 1 supplies, in the second period in the predetermined period T, the current of the current value 13 which is greater than the current value 10 to each of the laser diodes LD2 and LD3 other than the laser diode LD1 which has been lit for the entire first period (Step S407). Accordingly, a temperature decrease due to the laser diodes LD2 and LD3 being turned off is inhibited, whereby the projecting device 1 can continuously measure the chromaticity of the light emitted from the light source 11 accurately under a temperature condition similar to that at the time of image projection. In the second period, the chromaticity of the light is not measured.

After that, when the number of times of processing in the predetermined period T has not reached a preset number of times (NO in Step S408), the projecting device 1 returns to the processing in Steps S403-S407. On the other hand, when the number of times of processing in the predetermined period T has reached the preset number of times (YES in Step S408), the processing in the chromaticity measurement mode is ended. While the preset number of times is basically two or greater, it may be one provided the temperature is stable. The projecting device 1 calculates an average value of the results of measuring the chromaticity for the preset number of times and stores this average value in the light amount storage 35 as a final measurement result.

Referring once again to FIG. 9, the explanation will be continued. Next, the projecting device 1 determines whether or not the brightness of the light of the light source 11 at the reference point before aging degradation is stored in the light amount storage 35 (Step S303). When the brightness of the light of the light source 11 at the reference point is stored in the light amount storage 35 (YES in Step S303), the projecting device 1 ends the processing for measuring and storing the chromaticity and the brightness of the light of the light source 11 at the reference point. On the other hand, when the brightness of the light of the light source 11 at the reference point is not stored in the light amount storage 35 (NO in Step S303), the projecting device 1 measures the brightness of the light of the light source 11 at the reference point and stores the measurement results (Step S304).

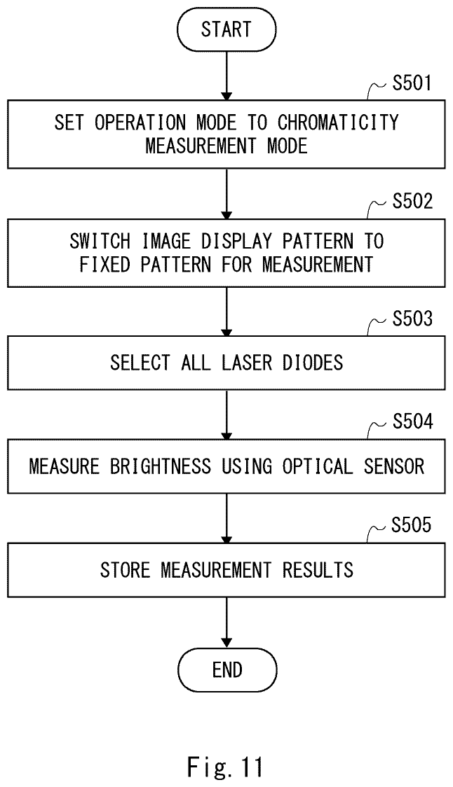

FIG. 11 shows detailed processing in Step S304, that is, detailed processing regarding measurement of the brightness and storage of measurement results. As shown in FIG. 11, first, the projecting device 1 sets an operation mode to a chromaticity measurement mode (Step S501). In accordance therewith, the projecting device 1 switches the image display pattern output from the image processor 30 as image data to a fixed pattern for measurement (Step S502). For example, the projecting device 1 switches the image display pattern output from the image processor 30 as image data to a fixed pattern of whole surface white. Accordingly, return light is inhibited.

After that, the projecting device 1 supplies the current of the current value 10 to each of all the laser diodes LD1-LD3 included in the light source 11, and measures brightness BA_ini of a combined light of the laser diodes LD1-LD3 that have thus been lit (Steps S503 and S504). The measurement results are stored in the light amount storage 35 (Step S505). Then the projecting device l ends the processing for measuring and storing the chromaticity and the brightness of the light of the light source 11 at the reference point.

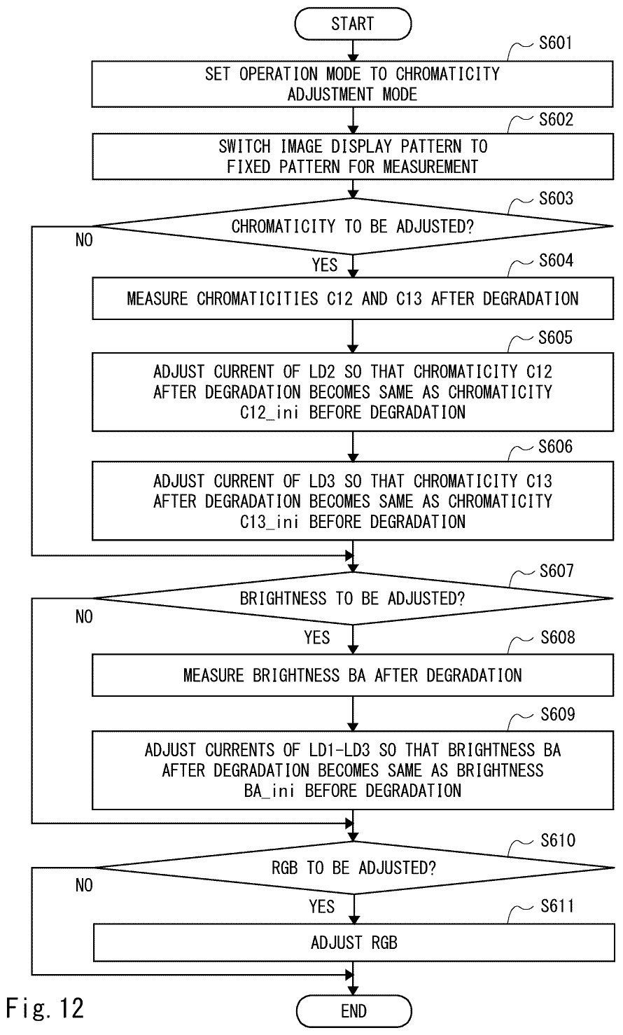

Next, with reference to FIG. 12, a method for measuring the chromaticity of the light after aging degradation and a method for adjusting the same by the projecting device 1 according to the third embodiment will be described. FIG. 12 is a flowchart showing a method for measuring the chromaticity of the light after aging degradation and a method for adjusting the same by the projecting device 1 according to the third embodiment. FIG. 12 also shows, in addition to the method for measuring the chromaticity of the light after aging degradation and the method for adjusting the same, a method for measuring brightness of the light after aging degradation and a method for adjusting the same.

First, the projecting device 1 sets the operation mode to the chromaticity adjustment mode (Step S601). In accordance therewith, the projecting device 1 switches the image display pattern output from the image processor 30 as image data to a fixed pattern for measurement (Step S602). For example, the projecting device 1 switches the image display pattern output from the image processor 30 as image data to a fixed pattern of whole surface white. Accordingly, return light is inhibited.

After that, the projecting device 1 determines whether or not to adjust the chromaticity of the light of the light source 11 after aging degradation (Step S603). When it is determined that the chromaticity of the light of the light source 11 after aging degradation is not to be adjusted (NO in Step S603), the projecting device 1 proceeds to the processing of Step S607. When it is determined that the chromaticity of the light of the light source 11 after aging degradation is to be adjusted (YES in Step S603), chromaticities C12 and C13 after aging degradation are measured in a method similar to the method for measuring chromaticity before aging degradation (Step S604).

After that, the projecting device 1 adjusts the current value of the current supplied to the laser diode LD2 in a state in which the current value supplied to the reference laser diode LD1 is fixed, thereby making the chromaticity C12 of the combined light of the laser diodes LD1 and LD2 approach the chromaticity C12_ini before aging degradation (ideally, they are made substantially the same) (Step S605). The projecting device 1 further adjusts the current value of the current supplied to the laser diode LD3 in the state in which the current value supplied to the reference laser diode LD1 is fixed, thereby making the chromaticity C13 of the combined light of the laser diodes LD1 and LD3 approach the chromaticity C13_ini at the reference point (ideally, they are made substantially the same) (Step S606). Accordingly, the ratio of the light amounts of the respective laser diodes LD1-LD3 approaches the one before aging degradation (ideally, they become substantially the same). After that, the projecting device 1 proceeds to the processing in Step S607.

After that, the projecting device 1 determines whether or not to adjust brightness of the light of the light source 11 after aging degradation (Step S607). When it is determined that the brightness of the light of the light source 11 after aging degradation is not to be adjusted (NO in Step S607), the projecting device 1 proceeds to the processing of Step S610. On the other hand, when it is determined that the brightness of the light of the light source 11 after aging degradation is to be adjusted (YES in Step S607), the brightness BA after aging degradation is measured in a method similar to the method for measuring the brightness before aging degradation (Step S608).

After that, the projecting device 1 adjusts the light amounts of the respective laser diodes LD1-LD3 in a state in which the ratio of the light amounts of the respective laser diodes LD1-LD3 is maintained, thereby causing the brightness BA of the light emitted from the light source 11 to approach the brightness BA_ini at the reference point (ideally, they are made substantially the same) (Step S609). After that, the projecting device 1 proceeds to the processing in Step S610.

After that, the projecting device 1 determines whether or not to adjust the RGB of the light of the light source 11 after aging degradation (Step S610). When the projecting device 1 has determined that the RGB of the light of the light source 11 after aging degradation is not to be adjusted (NO in Step S610), adjustment of the chromaticity and the like of the light of the light source 11 after aging degradation is ended. On the other hand, when the projecting device 1 has determined that the RGB of the light of the light source 11 after aging degradation is to be adjusted (YES in Step S610), adjustment of the RGB is performed (Step S611). The adjustment of the RGB is performed by adjusting an RGB gain of an image, an RGB offset of an image, and an RGB output of the light source 11. At this time, the adjustment of the RGB may be performed by referring to the result of the detection in the optical sensor 10, a measurement value of light projected onto the projected medium, setting values of the color or the brightness input by the user by using means such as OSD menus and communication commands. After that, the projecting device 1 ends the adjustment of the chromaticity and the like of the light of the light source 11 after aging degradation.

As described above, the projecting device 1 according to this embodiment compares results of measuring the chromaticity of the light emitted from the light source 11 before aging degradation with those after aging degradation, and separately controls currents supplied to the plurality of respective laser diodes based on the result of the comparison, thereby adjusting the chromaticity of the light emitted from the light source 11 after aging degradation in such a way that this chromaticity approaches the chromaticity before aging degradation. Here, in order to prevent the temperature of each of the laser diodes not to be measured which are not being lit from becoming lower than the temperature thereof at a time of image projection (in a normal operation) in a period in which chromaticity of the laser diode to be measured which is being lit is measured, the projecting device 1 temporarily supplies, in a period other than the measurement period, a current of a current value greater than that at a time of image projection to a specific laser diode. Accordingly, the projecting device 1 can accurately measure and adjust the chromaticity of the light emitted from the light source 11 under a temperature condition similar to that at a time of image projection (ideally, the same as that at the time of image projection).

Note that the timing when the operation mode is set to the chromaticity measurement mode may be any timing, and preferably, for example, it may be the timing when the power of the projecting device 1 is turned off after the projecting device 1 operates in the image projection mode. Accordingly, the projecting device 1 can measure the chromaticity from the laser diodes LD1-LD3 in a state in which the temperature is stable as the projecting device 1 operates in the image projection mode. Further, accordingly, the projecting device 1 can easily switch the image display pattern output from the image processor 30 as image data to a fixed pattern of whole surface white in which return light is inhibited.

Further, while the case in which the light source 11 includes three laser diodes LD1-LD3 has been described as an example in this embodiment, this is merely an example. The light source 11 may include any number of two or more laser diodes. In any case, one of a plurality of laser diodes included in the light source 11 is used as the reference laser diode. Further, like in the first and second embodiments, in this embodiment as well, a plurality of laser diodes having a common wavelength may be collectively driven to measure light amounts.

Further, while the case in which the current value of the current supplied to each of the laser diodes LD1-LD3 is constant when the operation mode is the image projection mode has been described as an example in this embodiment, this is merely an example. Even when the operation mode is the image projection mode, currents may be supplied to the respective laser diodes LD1-LD3 by current control the same as that performed when the operation mode is the chromaticity measurement mode. Accordingly, the projecting device 1 can cause each of the laser diodes LD1-LD3 to drive by a common current control regardless of the operation mode. In this case, in order to suppress flickering (flicker) of an image, the predetermined period T is preferably set to 14 ms or less.

Further, while the case in which the current value of the current supplied to each of the laser diodes LD1-LD3 is constant in the second period in the predetermined period T has been described as an example in this embodiment, this is merely one example, and it may not be constant. Note that, in order to prevent or reduce flickering (flicker) of an image, it is preferably constant.

Further, while the case in which the measurement of the chromaticities C12 and C13 and the measurement of the chromaticities C12_ini and C13_ini are continuously performed without intervals has been described as an example in this embodiment, this is merely an example. The measurement of the chromaticities C12 and C13 and the measurement of the chromaticities C12_ini and C13_ini may be sequentially performed at intervals. Accordingly, the projecting device 1 can perform processing performed by the optical sensor 10 and the light amount calculator 32, communication between the optical sensor 10 and the light amount calculator 32, and processing for storing measurement results in the light amount storage 35 in a period in which the chromaticity is not measured.

Note that the present disclosure is not limited to the above-described embodiments, and may be changed as appropriate without departing from the spirit of the present disclosure.

Further, the present disclosure can perform a part or the whole of control processing in the projecting device 1 by causing a Central Processing Unit (CPU) to execute a computer program.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the example embodiments disclosed above can be described as, but not limited to, the following supplementary notes.

### (Supplementary Note 1)

A chromaticity adjustment device comprising:
a drive circuit configured to separately drive each of first to third semiconductor lasers included in a light source, the first to third semiconductor lasers having wavelengths different from one another;
an optical sensor configured to detect light emitted from the light source;
an arithmetic processing circuit configured to calculate, based on a result of the detection by the optical sensor, at least chromaticity of light emitted from the light source;
a storage circuit configured to store a first chromaticity, which is a chromaticity of light from the light source when the first and second semiconductor lasers are driven at a reference point, and a second chromaticity, which is a chromaticity of light from the light source when the first and third semiconductor lasers are driven at the reference point; and
an adjustment circuit configured to adjust a current value of a current supplied from the drive circuit to the second semiconductor laser in such a way that a third chromaticity, which is a chromaticity of light from the light source when the first and second semiconductor lasers are driven after a passage of a first predetermined period from the reference point, approaches the first chromaticity and adjust a current value of a current supplied from the drive circuit to the third semiconductor laser in such a way that a fourth chromaticity, which is a chromaticity of light from the light source when the first and third semiconductor lasers are driven after a passage of a first predetermined period from the reference point, approaches the second chromaticity,
wherein the drive circuit:
   supplies, when an operation mode is an image projection mode, a current of a first current value to each of the first to third semiconductor lasers;
   periodically executes, when the operation mode is a chromaticity measurement mode, processing in a second predetermined period including a first period and a second period; and
   supplies, in processing of the second predetermined period, in the first period, the current of the first current value to each of the first and second semiconductor lasers and then supplies the current of the first current value to each of the first and third semiconductor lasers, and supplies, in the second period, the current of the first current value to the first semiconductor laser and supplies a current of a second current value which is greater than the first current value to each of the second and third semiconductor lasers, and
wherein the arithmetic processing circuit calculates the third chromaticity and the fourth chromaticity based on a result of the detection by the optical sensor in the first period in each of the second predetermined periods.

### (Supplementary Note 2)

The chromaticity adjustment device according to Supplementary Note 1,
wherein the light source further includes a fourth semiconductor laser having a wavelength different from those of the first to third semiconductor lasers,
the drive circuit is configured to be able to separately drive each of the first to fourth semiconductor lasers,
wherein the storage circuit further stores a fifth chromaticity, which is a chromaticity of the light from the light source when the first and fourth semiconductor lasers are driven at the reference point,
wherein the adjustment circuit is configured to further adjust a current value of a current supplied from the drive circuit to the fourth semiconductor laser in such a way that a sixth chromaticity, which is a chromaticity of the light from the light source when the first and fourth semiconductor lasers are driven after a passage of a first predetermined period from the reference point, approaches the fifth chromaticity,
wherein the drive circuit:
   supplies, when the operation mode is the image projection mode, a current of a first current value to each of the first to fourth semiconductor lasers,
   periodically executes, when the operation mode is the chromaticity measurement mode, processing in a second predetermined period including the first period and the second period; and
   supplies, in processing of the second predetermined period, in the first period, the current of the first current value to each of the first and second semiconductor lasers, then supplies the current of the first current value to each of the first and third semiconductor lasers, and then supplies the current of the first current value to each of the first and fourth semiconductor lasers, and supplies, in the second period, the current of the first current value to the first semiconductor laser and supplies a current of a second current value which is greater than the first current value to each of the second to fourth semiconductor lasers, and
wherein the arithmetic processing circuit calculates the sixth chromaticity in addition to the third chromaticity and the fourth chromaticity based on a result of the detection by the optical sensor in the first period in each of the second predetermined periods.

### (Supplementary Note 3)

The chromaticity adjustment device according to Supplementary Note 1,
wherein the light source further includes a fourth semiconductor laser that has a common wavelength with the second semiconductor laser,
wherein the drive circuit is configured to be able to separately drive each of the first to fourth semiconductor lasers,
wherein the storage circuit stores, as the first chromaticity, chromaticity of the light from the light source when the fourth semiconductor laser has been driven in addition to the first and second semiconductor lasers at the reference point,
wherein the adjustment circuit is configured to adjust current values of currents supplied from the drive circuit to the respective second and fourth semiconductor lasers in such a way that the third chromaticity, which is the chromaticity of the light from the light source when the fourth semiconductor laser has been driven in addition to the first and second semiconductor lasers after a passage of a first predetermined period from the reference point, approaches the first chromaticity,
wherein the drive circuit:
   supplies, when the operation mode is the image projection mode, a current of a first current value to each of the first to fourth semiconductor lasers,
   periodically executes, when the operation mode is the chromaticity measurement mode, processing in a second predetermined period including a first period and a second period; and
   supplies, in the processing of the second predetermined period, in the first period, the current of the first current value to the fourth semiconductor laser in addition to the first and second semiconductor lasers, and then supplies a current of the first current value to each of the first and third semiconductor lasers, and supplies, in the second period, the current of the first current value to the first semiconductor laser and supplies a current of a second current value which is greater than the first current value to each of the second to fourth semiconductor lasers, and
wherein the arithmetic processing circuit calculates the third chromaticity and the fourth chromaticity based on a result of detection by the optical sensor in the first period in each of the second predetermined periods.

According to the present disclosure, it is possible to provide a light amount measurement device, a projecting device, a light amount measurement method, and a control program suitable for accurately measuring a light amount of each of a plurality of semiconductor lasers having different wavelengths which are being lit, which are light sources.

What is claimed is:

1. A light measurement device comprising:
a drive circuit configured to separately drive each of a plurality of semiconductor lasers included in a light source;
an optical sensor configured to detect light emitted from the light source; and
an arithmetic processing circuit configured to calculate at least either of a light amount of each of the plurality of semiconductor lasers and chromaticity of the light emitted from the light source based on a result of the detection by the optical sensor.

2. A light measurement device according to claim 1,
wherein the drive circuit:
supplies, when an operation mode is an image projection mode, a current of a first current value to each of the plurality of semiconductor lasers;
periodically executes, when the operation mode is a light amount measurement mode, processing in a predetermined period including a first period and a second period; and
sequentially selects, in the processing in the predetermined period, in the first period, the plurality of semiconductor lasers for each group of one or more semiconductor lasers, supplies the current of the first current value to the semiconductor lasers in the selected group, stops supplying current to the other semiconductor lasers that are not selected, and supplies, in the second period, a current of a second current value which is greater than the first current value to each of the plurality of semiconductor lasers, and
wherein the arithmetic processing circuit calculates a light amount of each of the groups of the plurality of semiconductor lasers based on a result of the detection by the optical sensor in the first period in each of the predetermined periods.

3. The light measurement device according to claim 2, wherein, when the operation mode is the light amount measurement mode, the drive circuit sets the second current value in such a way that an each one of average current values of currents supplied to each of the semiconductor lasers in the predetermined period becomes substantially equal to the first current value.

4. A projecting device comprising:
the light source;
a reflective light modulator configured to modulate light emitted from the light source to reflect based on image data;
an optical projector configured to emit light modulated by the light modulator; and
the light measurement device according to claim 2 in which the optical sensor is provided between the light source and the light modulator.

5. A light measurement device according to claim 1,
wherein the drive circuit:
supplies, when an operation mode is an image projection mode, a current of a first current value to each of the plurality of semiconductor lasers;
periodically executes, when the operation mode is a light amount measurement mode, processing in a predetermined period including a first period and a second period; and
sequentially selects, in the processing in the predetermined period, in the first period, the plurality of semiconductor lasers for each group of one or more semiconductor lasers, stops supplying current to the semiconductor lasers in the selected group, supplies the current of the first current value to the remaining semiconductor lasers that are not selected, and supplies, in the second period, a current of a second current value which is greater than the first current value to each of the plurality of semiconductor lasers, and
wherein the arithmetic processing circuit calculates a light amount of each of the groups of the plurality of semiconductor lasers based on a result of the detection by the optical sensor in the first period in each of the predetermined periods.

6. The light measurement device according to claim 5, wherein, when the operation mode is the light amount measurement mode, the drive circuit sets the second current value in such a way that an each one of average current values of currents supplied to each of the semiconductor lasers in the predetermined period becomes substantially equal to the first current value.

7. A projecting device comprising:
the light source;
a reflective light modulator configured to modulate light emitted from the light source to reflect based on image data;
an optical projector configured to emit light modulated by the light modulator; and
the light measurement device according to claim 5 in which the optical sensor is provided between the light source and the light modulator.

8. The light measurement device according to claim 1,
wherein the plurality of semiconductor lasers are first to third semiconductor lasers having wavelength different from one another,
wherein the light measurement device further comprises:
a storage circuit configured to store a first chromaticity, which is a chromaticity of light from the light source when the first and second semiconductor lasers are driven at a reference point, and a second chromaticity, which is a chromaticity of light from the light source when the first and third semiconductor lasers are driven at the reference point; and
an adjustment circuit configured to adjust a current value of a current supplied from the drive circuit to the second semiconductor laser in such a way that a third chromaticity, which is a chromaticity of light from the light source when the first and second semiconductor lasers are driven after a passage of a first predetermined period from the reference point, approaches the first chromaticity and adjust a current value of a current supplied from the drive circuit to the third semiconductor laser in such a way that a fourth chromaticity, which is a chromaticity of light from the light source when the first and third semiconductor lasers are driven after a passage of a first predetermined period from the reference point, approaches the second chromaticity,
wherein the drive circuit:
supplies, when an operation mode is an image projection mode, a current of a first current value to each of the first to third semiconductor lasers;
periodically executes, when the operation mode is a chromaticity measurement mode, processing in a second predetermined period including a first period and a second period; and
supplies, in processing of the second predetermined period, in the first period, the current of the first current value to each of the first and second semiconductor lasers and then supplies the current of the first current value to each of the first and third semiconductor lasers, and supplies, in the second period, the current of the first current value to the first semiconductor laser and supplies a current of a second current value which is greater than the first current value to each of the second and third semiconductor lasers, and
wherein the arithmetic processing circuit calculates the third chromaticity and the fourth chromaticity based on a result of the detection by the optical sensor in the first period in each of the second predetermined periods.

9. The light measurement device according to claim 8, wherein, when the operation mode is the chromaticity measurement mode, the drive circuit sets the second current value in such a way that each of an average current value of currents supplied to the second semiconductor laser in the second predetermined period and an average current value of currents supplied to the third semiconductor laser in the second predetermined period becomes substantially equal to the first current value.

10. A projecting device comprising:
the light source;
a reflective light modulator configured to modulate light emitted from the light source to reflect based on image data;
an optical projector configured to emit light modulated by the light modulator; and
the light measurement device according to claim 8 in which the optical sensor is provided between the light source and the light modulator.

11. A light measurement method comprising:
separately driving each of a plurality of semiconductor lasers included in a light source;
detecting light emitted from the light source by an optical sensor; and
calculating at least either of a light amount of each of the plurality of semiconductor lasers and chromaticity of the light emitted from the light source based on a result of the detection by the optical sensor.

12. The light measurement method according to claim 11, further comprising:
supplying, when an operation mode is an image projection mode, a current of a first current value to each of the plurality of semiconductor lasers;
periodically executing, when the operation mode is a light amount measurement mode, processing in a predetermined period including a first period 10 and a second period;
sequentially selecting, in the processing in the predetermined period, in the first period, the plurality of semiconductor lasers for each group of one or more semiconductor lasers, supplying the current of the first current value to the semiconductor lasers in the selected group, and stopping supplying current to the other semiconductor lasers that are not selected, and supplying, in the second period, a current of a second current value which is greater than the first current value to each of the plurality of semiconductor lasers; and
calculating a light amount of each of the groups of the plurality of semiconductor lasers based on a result of the detection by the optical sensor in the first period in each of the predetermined periods.

13. The light measurement method according to claim 11, further comprising:
supplying, when an operation mode is an image projection mode, a current of a first current value to each of the plurality of semiconductor lasers;
periodically executing, when the operation mode is a light amount measurement mode, processing in a predetermined period including a first period and a second period;
sequentially selecting, in the processing in the predetermined period, in the first period, the plurality of semiconductor lasers for each group of one or more semiconductor lasers, stopping supplying current to the semiconductor lasers in the selected group, supplying the current of the first current value to the remaining semiconductor lasers that are not selected, and supplying, in the second period, a current of a second current value which is greater than the first current value to each of the plurality of semiconductor lasers; and
calculating a light amount of each of the groups of the plurality of semiconductor lasers based on a result of the detection by the optical sensor in the first period in each of the predetermined periods.

14. The light measurement method according to claim 11, wherein
the plurality of semiconductor lasers are first to third semiconductor lasers having wavelength different from one another, and
the light measurement method further comprises:
storing, in a storage circuit, a first chromaticity, which is a chromaticity of light from the light source when the first and second semiconductor lasers are driven at a reference point, and a second chromaticity, which is a chromaticity of light from the light source when the first and third semiconductor lasers are driven at the reference point;
adjusting, by an adjustment circuit, a current value of a supplied current to the second semiconductor laser in such a way that a third chromaticity, which is a chromaticity of light from the light source when the first and second semiconductor lasers are driven after a passage of a first predetermined period from the reference point, approaches the first chromaticity, and adjusting a current value of a supplied current to the third semiconductor laser in such a way that a fourth chromaticity, which is a chromaticity of light from the light source when the first and third semiconductor lasers are driven after a passage of a first predetermined period from the reference point, approaches the second chromaticity;
supplying, when an operation mode is an image projection mode, a current of a first current value to each of the first to third semiconductor lasers;
periodically executing, when the operation mode is a chromaticity measurement mode, processing in a second predetermined period including a first period and a second period;
supplying, in processing of the second predetermined period, in the first period, the current of the first current value to each of the first and second semiconductor lasers and then supplying the current of the first current value to each of the first and third semiconductor lasers, and supplying, in the second period, the current of the first current value to the first semiconductor laser and supplying a current of a second current value which is greater than the first current value to each of the second and third semiconductor lasers; and
calculating the third chromaticity and the fourth chromaticity based on a result of the detection by the optical sensor in the first period in each of the second predetermined periods.

15. A non-transitory computer readable medium storing a control program for causing a computer to execute:
processing for separately driving each of a plurality of semiconductor lasers included in a light source;
processing for detecting light emitted from the light source by an optical sensor; and
processing for calculating at least either of a light amount of each of the plurality of semiconductor lasers and chromaticity of the light emitted from the light source based on a result of the detection by the optical sensor.

16. The non-transitory computer readable medium according to claim 15, storing a control program for causing a computer to execute:
processing for supplying, when an operation mode is an image projection mode, a current of a first current value to each of the plurality of semiconductor lasers;
processing for periodically executing, when the operation mode is a light amount measurement mode, processing in a predetermined period including a first period and a second period;
processing for sequentially selecting, in the processing in the predetermined period, in the first period, the plurality of semiconductor lasers for each group of one or more semiconductor lasers, supplying the current of the first current value to the semiconductor lasers in the selected group, and stopping supplying current to the other semiconductor lasers that are not selected, and supplying, in the second period, a current of a second current value which is greater than the first current value to each of the plurality of semiconductor lasers; and
processing for calculating a light amount of each of the groups of the plurality of semiconductor lasers based on a result of the detection by the optical sensor in the first period in each of the predetermined periods.

17. The non-transitory computer readable medium according to claim 15, storing a control program for causing a computer to execute:
processing for supplying, when an operation mode is an image projection mode, a current of a first current value to each of the plurality of semiconductor lasers;
processing for periodically executing, when the operation mode is a light amount measurement mode, processing in a predetermined period including a first period and a second period;
processing for sequentially selecting, in the processing in the predetermined period, in the first period, the plurality of semiconductor lasers for each group of one or more semiconductor lasers, stopping supplying current to the semiconductor lasers in the selected group, supplying the current of the first current value to the remaining semiconductor lasers that are not selected, and supplying, in the second period, a current of a second current value which is greater than the first current value to each of the plurality of semiconductor lasers; and
processing for calculating a light amount of each of the groups of the plurality of semiconductor lasers based on a result of the detection by the optical sensor in the first period in each of the predetermined periods.

18. The non-transitory computer readable medium according to claim 15, storing a control program, wherein
the plurality of semiconductor lasers are first to third semiconductor lasers having wavelength different from one another, and
the control program causes the computer to execute:
processing for storing, in a storage circuit, a first chromaticity, which is a chromaticity of light from the light source when the first and second semiconductor lasers are driven at a reference point, and a second chromaticity, which is a chromaticity of light from the light source when the first and third semiconductor lasers are driven at the reference point;
processing for adjusting, by an adjustment circuit, a current value of a supplied current to the second semiconductor laser in such a way that a third chromaticity, which is a chromaticity of light from the light source when the first and second semiconductor lasers are driven after a passage of a first predetermined period from the reference point, approaches the first chromaticity and adjusting a current value of a supplied current to the third semiconductor laser in such a way that a fourth chromaticity, which is a chromaticity of light from the light source when the first and third semiconductor lasers are driven after a passage of a first predetermined period from the reference point, approaches the second chromaticity;
processing for supplying, when an operation mode is an image projection mode, a current of a first current value to each of the first to third semiconductor lasers;
processing for periodically executing, when the operation mode is a chromaticity measurement mode, processing in a second predetermined period including a first period and a second period;
processing for supplying, in processing of the second predetermined period, in the first period, the current of the first current value to each of the first and second semiconductor lasers and then supplying the current of the first current value to each of the first and third semiconductor lasers, and supplying, in the second period, the current of the first current value to the first semiconductor laser and supplying a current of a second current value which is greater than the first current value to each of the second and third semiconductor lasers; and
processing for calculating the third chromaticity and the fourth chromaticity based on a result of the detection by the optical sensor in the first period in each of the second predetermined periods.
